(19) United States
(12) Patent Application Publication
(10) Pub. No.: US 2017/0148218 A1
(43) Pub. Date: May 25, 2017

(54) ELECTRONIC APPARATUS AND OPERATION METHOD THEREOF

(71) Applicant: SAMSUNG ELECTRONICS CO., LTD., Suwon-si (KR)

(72) Inventors: Yong Yeon LEE, Suwon-si (KR); Jinah KONG, Seoul (KR); Yeo-Jun YOON, Seoul (KR); Yerin PARK, Seoul (KR); Yunkyung KIM, Suwon-si (KR)

(21) Appl. No.: 15/352,870

(22) Filed: Nov. 16, 2016

(30) Foreign Application Priority Data
Nov. 20, 2015 (KR) 10-2015-0163123

(51) Int. Cl. G06T 19/00; G06F 3/0346; G09G 5/00

(52) U.S. Cl. CPC G06T 19/006; G09G 5/003; G06F 3/0346; G06T 2215/16; G09G 2370/16

(57) ABSTRACT

A method of operating an electronic device according to various embodiments of the present disclosure may include: determining location information of an electronic device; detecting a content mapped to the determined location information; and mapping a content to the determined location information.

### CROSS-REFERENCE TO RELATED APPLICATION

This application is based on and claims priority under 35 U.S.C. §119 to Korean Application Serial No. 10-2015-0163123, which was filed in the Korean Intellectual Property Office on Nov. 20, 2015, the content of which is incorporated by reference herein in its entirety.

### TECHNICAL FIELD

The present disclosure relates generally to an electronic device and an operation method thereof, for example, to an electronic device and an operation method thereof for mapping a content onto location information.

### BACKGROUND

In general, electronic devices have various functions added thereto and perform the functions in combination. For example, electronic devices may perform mobile communication functions, data communication functions, image photographing functions, audio recording functions, and the like. As technologies have developed, electronic devices have been required to perform various user interface functions. Particularly, the desire for a realistic user interface which embraces the real environment and the operation of digital information has been rapidly increasing. The realistic user interface has been developed to maximize realism and to provide users with various types of extended experiences.

### SUMMARY

Various example embodiments of the present disclosure provide, through a transparent display unit, a realistic content which is digital information mapped onto a physical location.

According to various example embodiments of the present disclosure, a method of operating an electronic device is provided, the method including: determining location information of an electronic device; detecting a content mapped onto the determined location information; and mapping a content onto the determined location information.

According to various example embodiments of the present disclosure, an electronic device is provided, including: a first display unit comprising a first display and a second display unit comprising a second display, the second display being transparent; and a controller operably connected to the first display unit and the second display unit, wherein the controller is configured to: determine location information of the electronic device; detect a content that is mapped onto the determined location information; and map a content onto the determined location information.

An electronic device according to various example embodiments of the present disclosure and an operation method thereof may maximize and/or increase realism by naturally harmonizing a content with an ambient environment since a second display unit is embodied to be transparent. For example, when a background is projected onto the second display unit by the line of vision of a user, the user may determine the corresponding background and a mapped content in the second display unit, and thus, a user's experience may be extended. Therefore, a realistic user interface may be embodied through the second display unit, which induces the user to feel as if the content is displayed on the corresponding background. Also, user interaction may be extended by adjusting the level of the displayed content based on the distance between the electronic device and the corresponding background. Also, through a connection with a smart city infrastructure, the user may use the functions provided from the smart city infrastructure without installing a separate application in the electronic device.

An electronic device according to various example embodiments of the present disclosure and an operation method thereof may embody a realistic user interface by providing a user with emotion that directly maps a content onto a background projected onto the second display unit. Also, users who share space in a house may share contents with each other, so that the users may be induced to share experiences in the same space and communicate with each other.

### BRIEF DESCRIPTION OF THE DRAWINGS

The above and other aspects, features, and advantages of the present disclosure will become more apparent from the following detailed description, taken in conjunction with the accompanying drawings, in which like reference numerals refer to like elements, and wherein:

FIG. 1 is a block diagram illustrating an example electronic device according to various example embodiments of the present disclosure;

FIGS. 2 and 3 are diagrams illustrating examples of an electronic device embodied according to various example embodiments of the present disclosure;

FIG. 4 is a flowchart illustrating an example procedure of performing a method of operating an electronic device according to various example embodiments of the present disclosure;

FIG. 5 is a flowchart illustrating an example location information determining operation of FIG. 4;

FIG. 6 is a diagram illustrating an example operation of determining the location of the electronic device in FIG. 5;

FIG. 7 is a flowchart illustrating an example object determining operation of FIG. 5;

FIG. 8 is a diagram illustrating an example of a screen of an electronic device according to various example embodiments of the present disclosure;

FIG. 9 is a flowchart illustrating the example object determining operation of FIG. 5;

FIG. 10 is a diagram illustrating an example of a screen of an electronic device according to various example embodiments of the present disclosure;

FIG. 11 is a flowchart illustrating an example operation of displaying a content in a second display unit, described in FIG. 4;

FIGS. 12 and 13 are diagrams illustrating examples of a screen of an electronic device according to various example embodiments of the present disclosure;

FIG. 14 is a flowchart illustrating the example operation of displaying a content in a second display unit, described in FIG. 4;

FIGS. 15 and 16 are diagrams illustrating examples of a screen of an electronic device according to various example embodiments of the present disclosure;

FIG. 17 is a diagram illustrating an example operation of displaying a content in a second display unit;

FIG. 18 is a diagram illustrating an example of a screen of an electronic device according to various example embodiments of the present disclosure;

FIG. 19 is a diagram illustrating an example operation of displaying a content in a second display unit;

FIGS. 20 and 21 are diagrams illustrating examples of a screen of an electronic device according to various example embodiments of the present disclosure;

FIG. 22 is a flowchart illustrating the example operation of displaying a content in a second display unit, described in FIG. 4;

FIGS. 23 to 29 are diagrams illustrating examples of a screen of an electronic device according to various example embodiments of the present disclosure;

FIG. 30 is a flowchart illustrating the example operation of displaying a content in a second display unit, described in FIG. 4;

FIGS. 31 and 32 are diagrams illustrating examples of a screen of an electronic device according to various example embodiments of the present disclosure;

FIGS. 33 and 34 are diagrams illustrating examples of a screen of an electronic device according to various example embodiments of the present disclosure;

FIG. 35 is a flowchart illustrating an example content mapping operation of FIG. 4;

FIGS. 36 to 40 are diagrams illustrating examples of a screen of an electronic device according to various example embodiments of the present disclosure;

FIGS. 41 to 43 are diagrams illustrating examples of a screen of an electronic device according to various example embodiments of the present disclosure;

FIG. 44 is a flowchart illustrating the example content mapping operation of FIG. 4;

FIGS. 45 to 48 are diagrams illustrating examples of a screen of an electronic device according to various example embodiments of the present disclosure;

FIG. 49 is a block diagram illustrating an example electronic device and an external device according to various example embodiments of the present disclosure; and

FIGS. 50 and 51 are flowcharts illustrating an example operation method according to various example embodiments of the present disclosure.

### DETAILED DESCRIPTION

Hereinafter, various example embodiments of the present disclosure will be described with reference to the accompanying drawings. The embodiments and the terms used therein are not intended to limit the technology disclosed herein to specific forms, and should be understood to include various modifications, equivalents, and/or alternatives to the corresponding embodiments. In describing the drawings, similar reference numerals may be used to designate similar constituent elements. As used herein, singular forms may include plural forms as well unless the context clearly indicates otherwise. As used herein, singular forms may include plural forms as well unless the context clearly indicates otherwise. The expression “a first”, “a second”, “the first”, or “the second” may modify corresponding elements regardless of the order or importance, and is used only to distinguish one element from another element, but does not limit the corresponding elements. When an element (e.g., first element) is referred to as being “(functionally or communicatively) connected,” or “directly coupled” to another element (second element), the element may be connected directly to the another element or connected to the another element through yet another element (e.g., third element).

The expression “configured to” as used in various embodiments of the present disclosure may be interchangeably used with, for example, “suitable for”, “having the capacity to”, “designed to”, “adapted to”, “made to”, or “capable of” in terms of hardware or software, according to circumstances. Alternatively, in some situations, the expression “device configured to” may refer, for example, to the device, together with other devices or components, “is able to”. For example, the phrase “processor adapted (or configured) to perform A, B, and C” may refer, for example, to a dedicated processor (e.g., embedded processor, processing circuitry, etc.) for performing the corresponding operations or a generic-purpose processor (e.g., central processing unit (CPU) or application processor (AP)) that can perform the corresponding operations by executing one or more software programs stored in a memory device.

An electronic device according to various embodiments of the present disclosure may include at least one of, for example, a smart phone, a tablet Personal Computer (PC), a mobile phone, a video phone, an electronic book reader (e-book reader), a desktop PC, a laptop PC, a netbook computer, a workstation, a server, a Personal Digital Assistant (PDA), a Portable Multimedia Player (PMP), a MPEG-1 audio layer-3 (MP3) player, a mobile medical device, a camera, and a wearable device. According to various embodiments, the wearable device may include at least one of an accessory type (e.g., a watch, a ring, a bracelet, an anklet, a necklace, a glasses, a contact lens, or a Head-Mounted Device (HIVID)), a fabric or clothing integrated type (e.g., an electronic clothing), a body-mounted type (e.g., a skin pad, or tattoo), and a bio-implantable type (e.g., an implantable circuit). In some embodiments, the electronic device may include at least one of, for example, a television, a Digital Video Disk (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and PlayStation™), an electronic dictionary, an electronic key, a camcorder, and an electronic photo frame, or the like, but is not limited thereto.

In other embodiments, the electronic device may include at least one of various medical devices (e.g., various portable medical measuring devices (a blood glucose monitoring device, a heart rate monitoring device, a blood pressure measuring device, a body temperature measuring device, etc.), a Magnetic Resonance Angiography (MRA), a Magnetic Resonance Imaging (MRI), a Computed Tomography (CT) machine, and an ultrasonic machine), a navigation device, a Global Positioning System (GPS) receiver, an Event Data Recorder (EDR) , a Flight Data Recorder (FDR) , a Vehicle Infotainment Devices, an electronic devices for a ship (e.g., a navigation device for a ship, and a gyro-compass), avionics, security devices, an automotive head unit, a robot for home or industry, an automatic teller's machine (ATM) in banks, point of sales (POS) in a shop, or internet device of things (e.g., a light bulb, various sensors, electric or gas meter, a sprinkler device, a fire alarm, a thermostat, a streetlamp, a toaster, a sporting goods, a hot water tank, a heater, a boiler, etc.), or the like, but is not limited thereto. According to some embodiments, an electronic device 100 may include at least one of a part of furniture or a building/structure, an electronic board, an electronic signature receiving device, a projector, and various types of measuring instruments (e.g., a water meter, an electric meter, a gas meter, a radio wave meter, and the like), or the like, but is not limited thereto. In various embodiments, the electronic device 100 may be flexible, or may be a combination of one or more of the aforementioned various devices. The electronic device according to one embodiment of the present disclosure is not limited to the above described devices. In the present disclosure, the term “user” may indicate a person using an electronic device or a device (e.g., an artificial intelligence electronic device) using an electronic device.

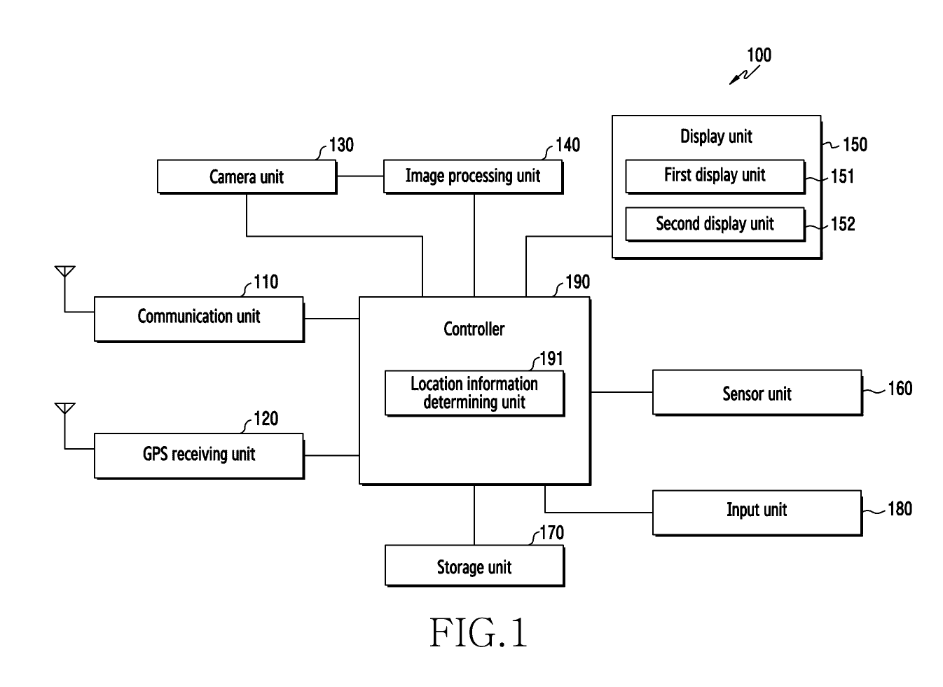

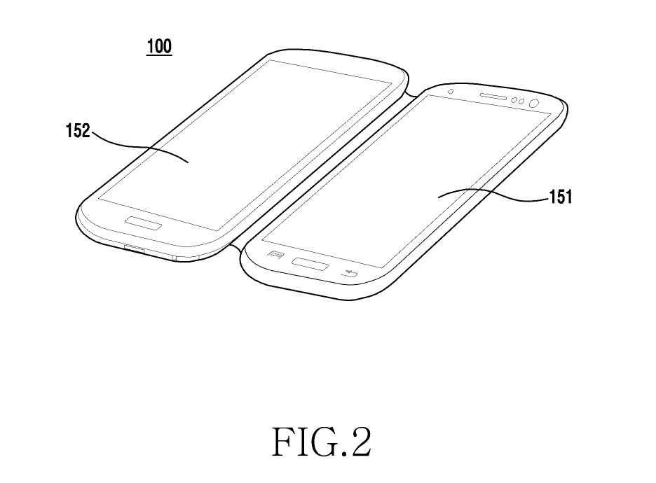

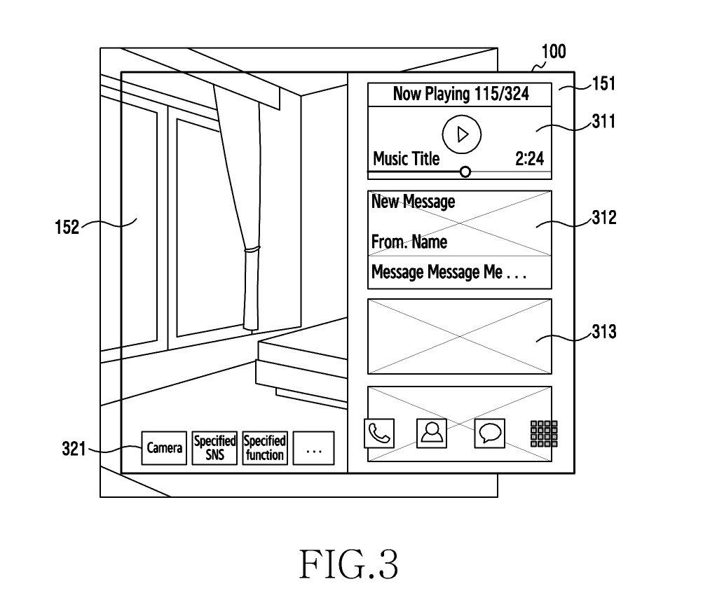

FIG. 1 is a block diagram illustrating an example electronic device according to various example embodiments of the present disclosure. FIGS. 2 and 3 are diagrams illustrating examples of an electronic device embodied according to various example embodiments of the present disclosure.

Referring to FIG. 1, an electronic device 100 according to various embodiments of the present disclosure includes a communication unit (e.g., including communication circuitry) 110, a GPS receiving unit (e.g., including GPS receiving circuitry) 120, a camera unit (e.g., including a camera) 130, an image processing unit (e.g., including processing circuitry) 140, a display unit (e.g., including at least one display) 150, a sensor unit (e.g., including sensor or sensing circuitry) 160, a storage unit 170, an input unit (e.g., including input circuitry) 180, and a controller (e.g., including processing circuitry) 190. The electronic device 100 according to various example embodiments of the present disclosure may map a content onto a physical space, and may determine the mapped content.

The communication unit 110 may include various communication circuitry to perform wireless communication in the electronic device 100. The communication unit 110 may communicate with an external device (not illustrated) through various communication schemes. For example, the external device may include an electronic device, a base station, a server, and a satellite. To this end, the communication unit 110 may access at least one of a mobile communication network, a data communication network, and a short range communication network. For example, the communication scheme may include at least one out of long term evolution (LTE), LTE Advance (LTE-A), code division multiple access (CDMA), wideband code division multiple access (WCDMA), universal mobile telecommunications system (UMTS), wireless broadband (WiBro), global system for mobile communications (GSM), wireless fidelity (WiFi), Bluetooth, near field communications (NFC), and global navigation satellite system (GNSS).

The GPS receiving unit 120 may include various GPS receiving circuitry to receive the location of the electronic device 100 through a global positioning system (GPS). The GPS receiving unit 120 may include at least one out of a global navigation satellite system (Glonass), Beidou navigation satellite system (Beidou), and the European global satellite-based navigation system (Galileo), instead of a GPS.

The camera unit 130 may include at least one camera to photograph image data in the electronic device 100. The camera unit 130 may include a camera sensor and a signal processing unit. The camera sensor may convert an optical signal into an electrical image signal. The signal processing unit may convert an analog image signal into digital image data. The camera sensor and the signal processing unit may be integrally or separately embodied. For example, the camera sensor may include a CCD sensor and a CMOS sensor, and the signal processing unit may include a digital signal processor (DSP).

The image processing unit 140 may include various processing circuitry to process image data into display data in the electronic device 100. The image processing unit 140 may process image data based on a frame unit, and may match the same to the feature and the size of the display unit 150. The image processing unit 140 may include an image codec, and may compress image data or decompress the compressed image data. For example, the image codec may include a JPEG codec, an MPEG4 codec, and a Wavelet codec.

The display unit 150 may include at least one display to output display data in the electronic device 100. The display data may represent information processed in the electronic device 100. For example, the display unit 150 may include various displays, such as, for example, and without limitation, at least one out of a liquid crystal display (LCD), a light emitting diode (LED) display, an organic LED (OLED) display, a micro electro mechanical system (MEMS) display, and an electronic paper display.

The display unit 150 may include a plurality of display units 151 and 152. For example, as illustrated in FIGS. 2 and 3, the display unit 150 may include a first display unit 151 and a second display unit 152. At least one of the first display unit 151 and the second display unit 152 may be provided in the form of a touch screen, and may input an input signal from a user. When an input signal is input, the controller 190 may perform controlling to display information corresponding to the input signal in at least one of the first display unit 151 and the second display unit 152. The first display unit 151 and the second display unit 152 may be functionally connected. The first display unit 151 and the second display unit 152 may be electrically or physically connected. The first display unit 151 and the second display unit 152 may be electrically connected, and may share driving power. The second display unit 152 may display an image in connection with the first display unit 151.

For example, the first display unit 151 and the second display unit 152 may be physically connected. For example, the first display unit 151 and the second display unit 152 may be connected through a separate case. The case may be formed to be hinged, and may connect the first display unit 151 and the second display unit 152. The first display unit 151 and the second display unit 152 may be connected in a folding form. For example, the second display unit 152 may act as a cover that opens and closes the first display unit 151. The first display unit 151 and the second display unit 152 may be detached from each other.

As illustrated in FIG. 3, the first display unit 151 may display various contents 311, 312, and 313. The contents 311, 312, and 313 may respectively correspond a plurality of applications that are executed in the electronic device 100. Alternatively, the contents may be text, images, videos, icons, symbols, or the like. The second display unit 152 may be embodied to be transparent. A background, a person, an object, or the like may be projected onto the second display unit 152. For example, when the electronic device 100 is located in a place in a house, the scene of the place in the house that is viewed by a user through the second display unit 152 may be projected onto the second display unit 152. The second display unit 152 may display function icons 321 that are capable of performing various functions. For example, the function icons 321 may include an icon for activating the camera unit 130, an icon for activating an SNS function, an icon for executing a specified function, or the like.

Referring again to FIG. 1, the sensor unit 160 may include various sensors or sensing circuitry that, for example, measure a physical quantity or detect the operating state of the electronic device 100, and may convert the measured or detected information into an electrical signal. The sensor unit 160 may include, for example, and without limitation, at least one of a gesture sensor, a gyro sensor, an atmospheric pressure sensor, a magnetic sensor, an acceleration sensor, a grip sensor, a proximity sensor, a color sensor (e.g., a red, green, and blue (RGB) sensor), a biometric sensor, a temperature/humidity sensor, an illumination sensor, and an ultraviolet (UV) sensor. Additionally or alternatively, the sensor unit 160 may include, for example, an E-nose sensor, an electromyography (EMG) sensor, an electroencephalogram (EEG) sensor, an electrocardiogram (ECG) sensor, an Infrared (IR) sensor, an iris sensor, and/or a fingerprint sensor. The sensor unit 160 may further include a control circuit for controlling at least one sensor included therein.

The storage unit 170 may store operation programs of the electronic device 100. The storage unit 170 may store a program for mapping information onto a space, or for determining the information. The storage unit 170 may store data that is generated while programs are being executed. The storage unit 170 may store mapping information. The mapping information includes location information and a content that is mapped onto the corresponding location. Therefore, the storage unit 170 may store the location information and a content mapped onto the corresponding location.

The input unit 180 may include various input circuitry configured to generate input data in the electronic device 100. The input unit 180 may generate input data in response to a user input from the electronic device 100. For example, the input unit 180 may include various input circuitry, such as, for example, and without limitation, a key pad, a dome switch, a physical button, a touch panel, a jog & shuttle, and a sensor. The input unit 180 may be embodied as a touch screen by being coupled with the display unit 150.

The controller 190 may include various processing circuitry configured to control an overall operation of the electronic device 100. In this instance, the controller 190 may perform various functions. To this end, the controller 190 may control the elements of the electronic device 100. The controller 190 may receive instructions or data from elements of the electronic device 100, and may process the same. The controller 190 may determine location information. The controller 190 may obtain location information through at least one out of the communication unit 110, the GPS receiving unit 120, the camera unit 130, the image processing unit 140, and the sensor unit 160. The controller 190 may include a location information determining unit 191. The controller 190 may determine location information and map a content. The controller 190 may determine location information, and may perform controlling to display a content that is mapped onto the corresponding location. The controller 190 may detect a content that is mapped onto the location information that is determined through the storage unit 170.

According to an embodiment of the present disclosure, the electronic device may include a first display unit; a second display unit which is transparent; and a controller that is functionally connected to the first display unit and the second display unit. The controller may determine the location information of the electronic device, may detect a content mapped onto the determined location information, and may map a content onto the determined location information.

According to an embodiment of the present disclosure, the controller may determine the location of the electronic device, and may determine whether an object that faces the electronic device exists.

According to an embodiment of the present disclosure, the electronic device further includes a sensor unit.

The sensor unit may determine the directionality of the electronic device.

According to an embodiment of the present disclosure, the object may include at least one of an external device that is capable of performing short-range communication and an image obtained from a subject.

According to an embodiment of the present disclosure, when a content mapped onto the determined location information is detected, the controller may display the mapped content in the second display unit.

According to an embodiment of the present disclosure, the controller may display the mapped content in the second display unit.

According to an embodiment of the present disclosure, the electronic device further includes a communication unit.

The communication unit may receive the mapped content from an external device.

According to an embodiment of the present disclosure, the controller may display a mappable content in the first display unit, may receive an input that selects at least one out of the mappable contents, and may display the selected content in the second display unit that is transparent.

According to an embodiment of the present disclosure, the controller displays at least one candidate object, receives an input for selecting one of the at least one object, and maps a content onto the selected object.

According to an embodiment of the present disclosure, the controller may write a message, and may transmit the message together with the determined location information.

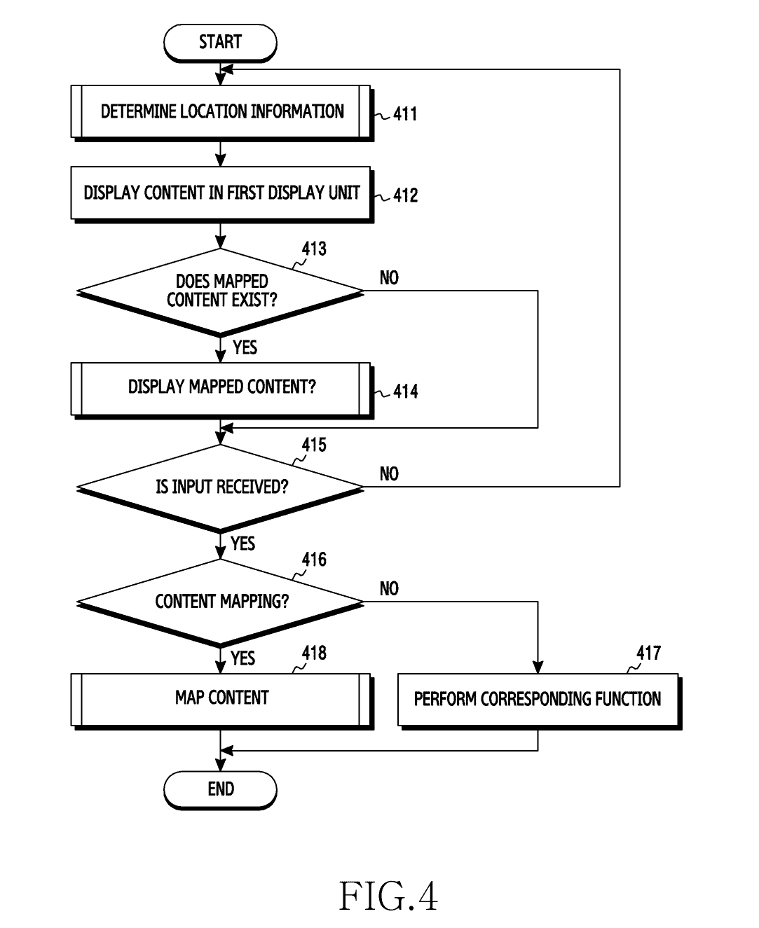

FIG. 4 is a flowchart illustrating an example procedure of performing a method of operating an electronic device according to various example embodiments of the present disclosure.

As illustrated in FIG. 4, the controller 190 may determine location information in operation 411. The location information may be a concept including at least one out of the location of the electronic device 100, the directionality of the electronic device, and an object. For example, the location information may be a concept including the location of the electronic device 100, which is determined through the GPS receiving unit 120 or the communication unit 110. Alternatively, the location information may be a concept including the directionality of the electronic device 100 that is determined through the sensor unit 160. Alternatively, the location information may be a concept including an external device that is capable of performing short-range communication through the communication unit 110 and/or an image that is obtained through the camera unit 130. The controller 190 may periodically determine location information. Alternatively, the controller 190 may determine location information by request of a user of the electronic device 100.

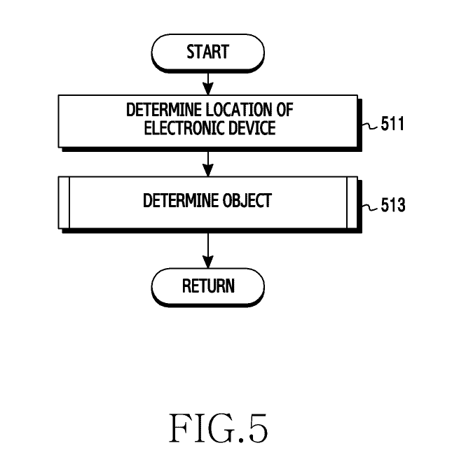

FIG. 5 is a flowchart illustrating an example location information determining operation of FIG. 4.

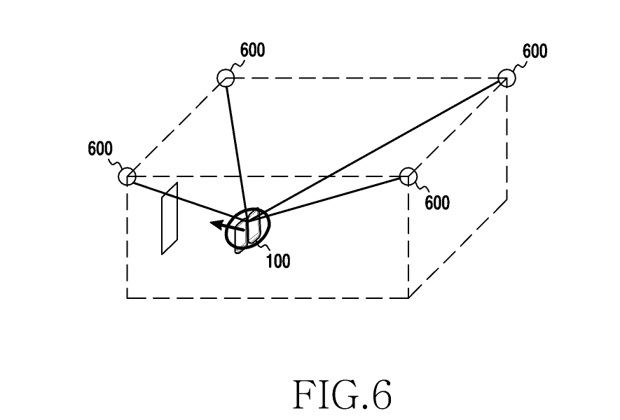

As illustrated in FIG. 5, the controller 190 may determine the location of the electronic device 100 in operation 511. For example, the location of the electronic device 100 may be received from a satellite through the GPS receiving unit 120 periodically or at a predetermined point in time, and may be determined. The location of the electronic device 100 may include at least one out of the longitude, the latitude, the altitude, the coordinate value, time information, and speed information in association with a point where the electronic device 100 is located. According to various embodiments of the present disclosure, the controller 190 may determine the location of the electronic device 100 based on a signal received from the communication unit 110. For example, FIG. 6 is a diagram illustrating an example operation of determining the location of the electronic device in FIG. 5. Referring to the FIG. 6, the controller 190 may determine the distances to external devices 600 and the directions thereof based on a signal received from the neighbor external devices 600. According to an embodiment of the present disclosure, the controller 190 may communicate with the external devices 600 through short-range communication infrastructures, for example, Bluetooth (BT) or Zigbee. For example, the controller 190 may measure a received signal strength indication (RS SI) of a signal received from the external devices 600, and may determine the distances to the external devices 600 and the directions thereof. Through the above, the controller 190 may determine the location of the electronic device 100 based on the triangulation method.

The controller 190 may determine the directionality of the electronic device 100 in operation 511. As described above, the location information of the electronic device 100 may be information that is obtained by additionally taking into consideration the directionality of the electronic device 100. According to an embodiment of the present disclosure, the location of the electronic device 100 may further include the point of the compass of the direction in which the electronic device 100 faces (the direction in which the electronic device 100 looks) and the angle of the electronic device 100 from the ground. The controller 190 may determine the directionality of the electronic device 100 through the sensor unit 160. For example, the controller 190 may determine the directionality of the electronic device 100 using a movement detection sensor or a gesture sensor. The controller 190 may determine the direction in which the electronic device 100 faces as at least one of east, west, south, north, up, and down. According to various embodiments of the present disclosure, the controller 190 may determine a change in the rotation angle or the point of the compass of the electronic device 100 through a gyro sensor or an acceleration sensor. According to various embodiments of the present disclosure, the controller 190 may determine the point of compass of the electronic device 100 through a terrestrial magnetism sensor. According to an embodiment of the present disclosure, the controller 190 may determine the directionality of the electronic device 100 by detecting a change in the terrestrial magnetism direction or the altitude through a terrestrial magnetism sensor.

The controller 190 may determine an object in operation 513. The object may be an external device that is capable of performing short-range communication or an image that is obtained from a subject. According to various embodiments of the present disclosure, when the controller 190 determines the location information based on only the location of the electronic device 100 and/or the directionality of the electronic device 100, which is determined in operation 511, the controller 190 may omit operation 513.

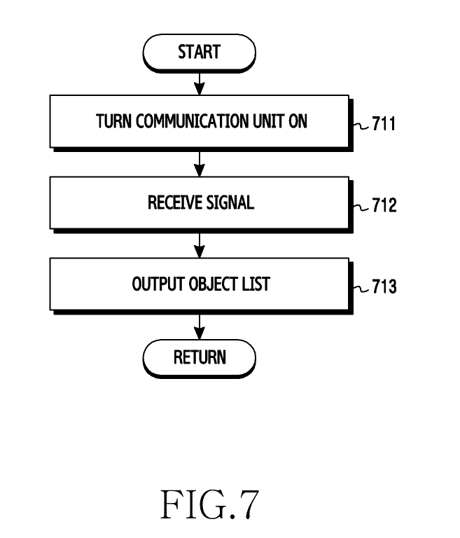

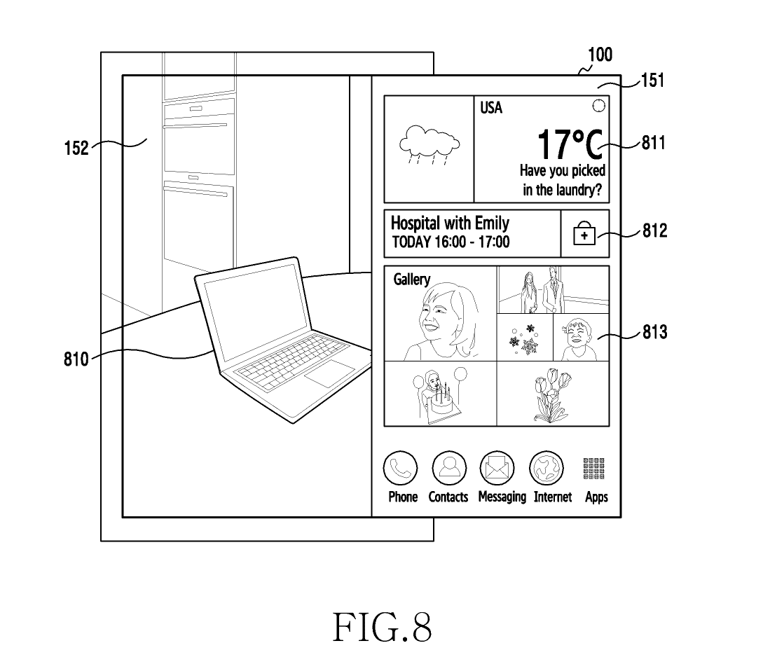

FIG. 7 is a flowchart illustrating an example object determining operation of FIG. 5. FIG. 8 is a diagram illustrating an example of a screen of the electronic device 100 according to various example embodiments of the present disclosure. FIG. 7 illustrates an example in which an object is, for example, an external device that is capable of performing short-range communication. The external device capable of performing short-range communication may be the electronic device 100 or a base station, for example, a TV, a PC, a notebook, a Bluetooth speaker, or audio device, or the like, which is equipped with a communication module, but is not limited thereto.

As illustrated in FIG. 7, the controller 190 may activate the communication unit 110 to be turned on in operation 711. The controller 190 may receive a signal in operation 712. According to an embodiment of the present disclosure, the controller 190 may receive a signal associated with short-range communication in operation 712. The controller 190 may output a list of received short-range communication addresses in operation 713. According to an embodiment of the present disclosure, the controller 190 outputs a list of objects in operation 713. The list of objects may be candidate objects that may be selectable when content mapping is performed. The list may include short-range communication through an external device such as a notebook 810, which is projected onto the second display unit 152. Therefore, the controller 190 may determine the location information based on the location of the electronic device 100 determined in operation 511 and the object determined in operation 513. According to an embodiment of the present disclosure, the controller 190 may determine the location information based on the location of the electronic device 100 determined in operation 511 and the list of short-range communications received in operation 712.

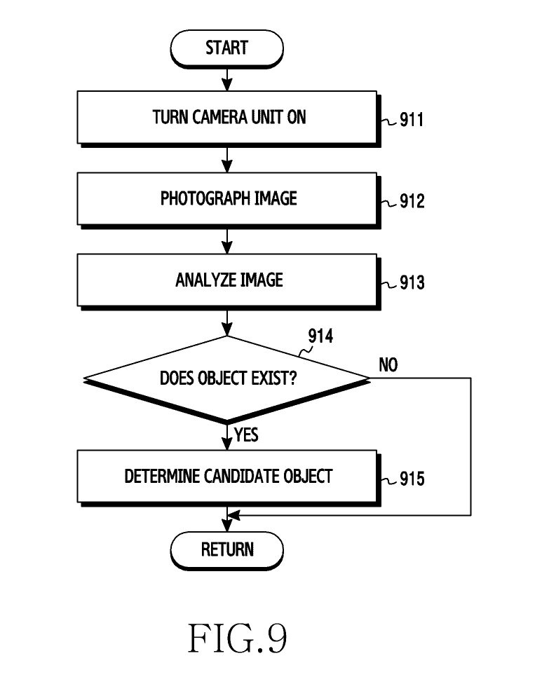

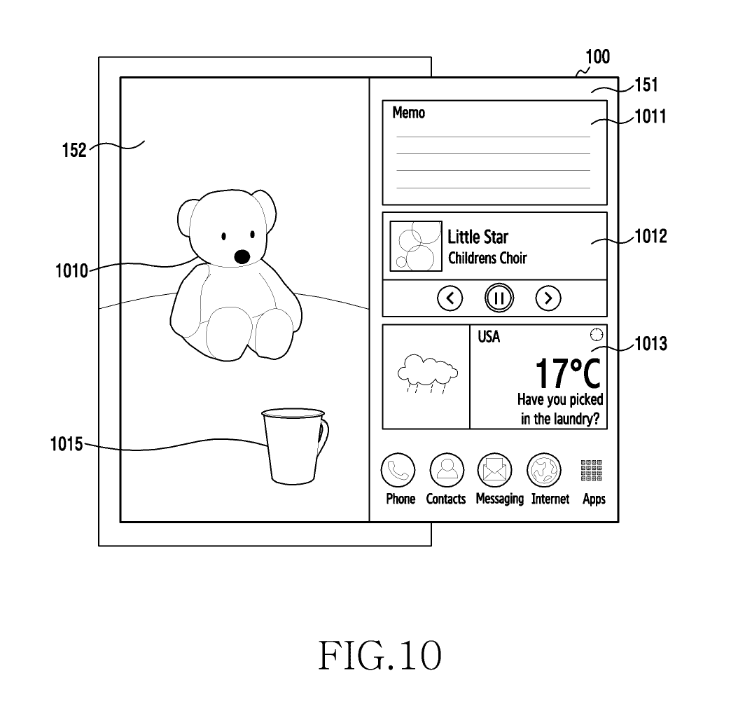

FIG. 9 is a flowchart illustrating the example object determining operation of FIG. 5. FIG. 10 is a diagram illustrating an example of a screen of the electronic device 100 according to various example embodiments of the present disclosure. FIG. 9 illustrates an example in which an object is, for example, an image obtained from a subject.

As illustrated in FIG. 9, the controller 190 may activate the camera unit 130 to be turned on in operation 911. The controller 190 may control the camera unit 130 to photograph an image corresponding to a subject in operation 912. As illustrated in FIG. 10, the first display unit 151 displays various contents 1011, 1012, and 1013, and the like, and a subject that the camera unit 130 desires to photograph is projected onto the second display unit 152. According to an embodiment of the present disclosure, the camera unit may photograph an image of a subject (e.g., a teddy bear or a cup) projected onto the second display unit 152.

The controller 190 may obtain image data from the camera unit 130 in operation 912. According to an embodiment of the present disclosure, the controller 190 may obtain image data in response to photographing performed by the camera unit 130.

The controller 190 may analyze an image 1010 and 1015 from the obtained image data in operation 913. The controller 190 may analyze whether an image that is parsable exists in the image data.

The controller 190 may determine whether an object exists in operation 914. According to an embodiment of the present disclosure, the controller 190 may determine whether a parsed image exists in operation 914.

When it is determined that the parsed image 1010 and 1015 exists, the controller 190 may determine the parsed image 1010 and 1015 as a candidate object in operation 915. The controller 190 may emphasize and display the parsed image 1010 and 1015. For example, the controller 190 may emphasize the parsed image 1010 and 1015 by displaying the border of the parsed image 1010 and 1015 in a bold line, or by putting a flickering mark on the border of the parsed image 1010 and 1015. The controller 190 may determine the parsed image 1010 and 1015 as an object to which content mapping is possible. The controller 190 may determine the parsed image 1010 and 1015 as an object by generally taking into consideration the size, the form, the color, and the like of the parsed image 1010 and 1015. Therefore, the controller 190 may determine the location information through the location of the electronic device 100 determined in operation 511 and the candidate object determined in operation 513. According to an embodiment of the present disclosure, the controller 190 may determine the location information based on the location of the electronic device 100 determined in operation 511 and the parsed image 1010 and 1015 that is obtained in operation 913.

Referring again to FIG. 4, the controller 190 may display a content in the first display unit 151 in operation 412. As described in FIGS. 3, 8, and 10, the controller 190 may display various contents 311, 312, 313, 811, 812, 813, 1011, 1012, and 1013 in the first display unit 151. The controller 190 may display a mappable content in the first display unit 151 based on the location information. Alternatively, the controller 190 may display, in the first display unit 151, information associated with a content displayed in the second display unit 152.

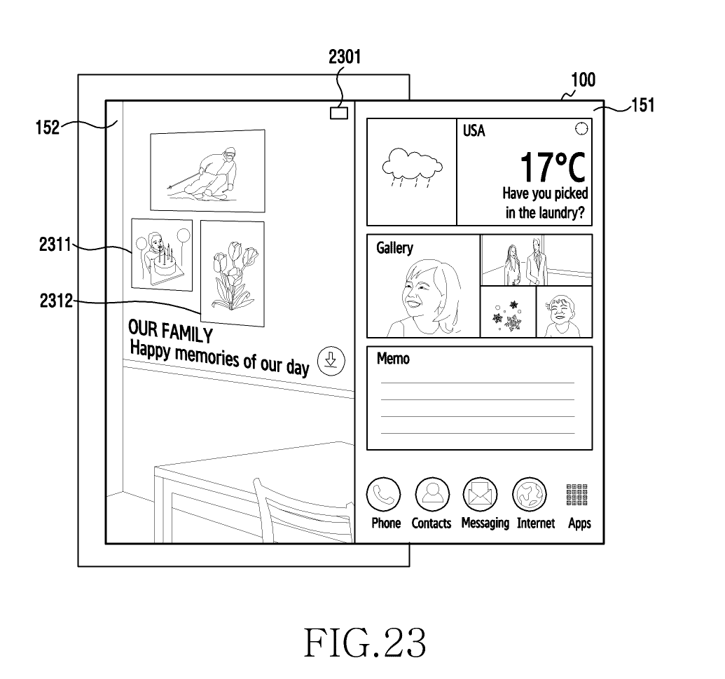

The controller 190 may determine whether a content exists that is mapped onto the determined location information in operation 413. For example, the controller 190 may determine whether a content corresponding to the location information exists using the storage unit 170 of the electronic device 100. According to various embodiments of the present disclosure, the controller 190 may determine whether a content that is mapped onto an object exists through the transmission/reception of a signal with the corresponding object that is capable of performing short-range communication. According to various embodiments of the present disclosure, the controller 190 determines whether a content that is mapped onto an object corresponding to a parsed image exists. According to an embodiment of the present disclosure, a parsed image and an object to which a content is mapped may be determined by comparing various pieces of information such as the sizes, the forms, the colors, and the like of them. According to various embodiments of the present disclosure, the controller 190 may determine whether a content corresponding to location information exists through a signal received from an external device. When a content mapped onto an external device 2301 exists as illustrated in FIG. 23, the electronic device 100 receives a signal from the external device 2301, and the controller 190 may determine that the mapped content exists through the external device 2301.

When a mapped content exists, the controller 190 may display the mapped content in the second display unit 152 in operation 414. The operation of displaying the mapped content in the second display unit 152 may change based on: an example in which a content exists that is mapped onto location information determined based on the location of the electronic device 100, or an example in which a content exists that is mapped onto location information determined based on the location of the electronic device 100 and a candidate object that is capable of performing short-range communication, which is output in operation 712. According to various embodiments of the present disclosure, the operation may change based on an example in which a content exists that is mapped onto location information determined based on the location of the electronic device 100 and a candidate object which is an image parsed in operation 913. According to various embodiments of the present disclosure, the operation may change based on an example in which a content that is mapped onto an external device exists. According to various embodiments of the present disclosure, the operation may change based on an example in which a content exists that is mapped onto a message received from the outside.

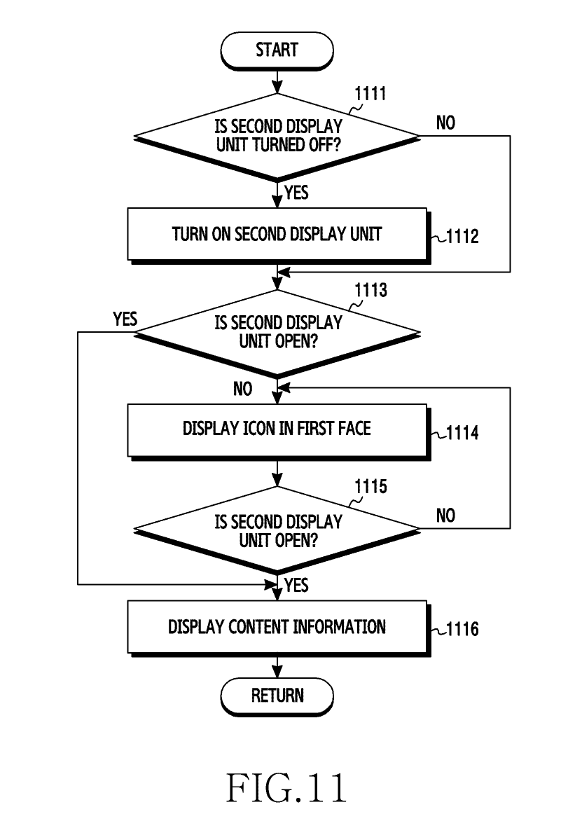

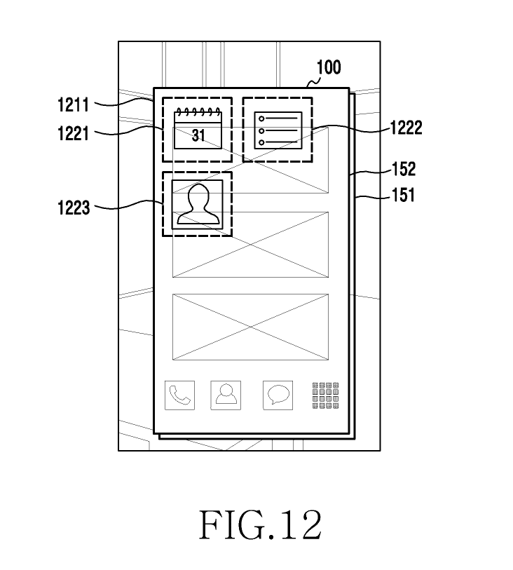

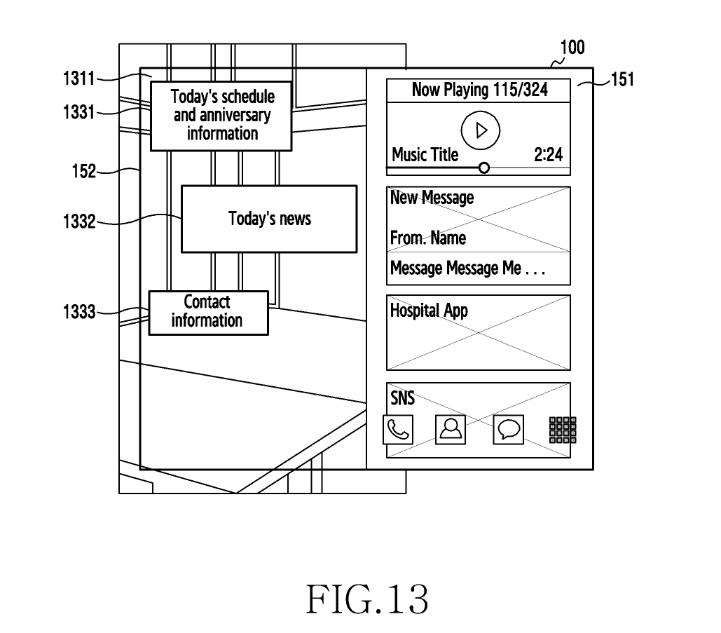

FIG. 11 is a flowchart illustrating the example operation of displaying a content in the second display unit 152, described in FIG. 4. FIGS. 12 and 13 are diagrams illustrating examples of a screen of the electronic device 100 according to various example embodiments of the present disclosure. FIGS. 11 to 13 illustrate an example in which a content exists that is mapped onto location information determined based on the location of the electronic device 100.

As illustrated in FIG. 11, the controller 190 may determine whether the second display unit 152 is turned off in operation 1111.

When it is determined that the second display unit 152 is turned off, the controller 190 may change the second display unit 152 to be turned on in operation 1112. According to an embodiment of the present disclosure, the controller 190 may activate the second display unit 152 in operation 1112.

When it is determined that the second display unit 152 is not turned off, the controller 190 may perform operation 1113. The controller 190 may determine whether the second display unit 152 is open in operation 1113. According to various embodiment of the present disclosure, the second display unit 152 may be embodied to open and close the first display unit 151, like a cover. When it is determined that the second display unit 152 is not open in operation 1113, the controller 190 may display an icon in a first face (or a first side) of the second display unit 152 in operation 1114. According to an embodiment of the present disclosure, as illustrated in FIG. 12, when the second display unit 152 is closed, as opposed to being open, the first display unit 151 and the second display unit 152 may be disposed to overlap with each other. Since the second display unit 152 is transparent, even when the second display unit 152 is closed, a user may determine various contents 1201, 1202, and 1203 displayed in the first display unit 151. The second display unit 152 may display at least one icon 1221, 1222, and 1223 which indicates a mapped content exists, in the first face 1211 which is the front side (a side that faces a user) when the second display unit 152 is closed. For example, a predetermined content, a news content, and a contact content are mapped onto determined location information, the controller 190 may display, in the first face 1211 of the second display unit 152, an icon 1221 indicating that the predetermined content is mapped, an icon 1222 indicating that the news content is mapped, and an icon 1223 indicating that the contact content is mapped. The example may not be limited thereto, and the controller 190 may display information indicating that a mapped content exists in various schemes. The controller 190 may determine whether the second display unit 152 is switched to be open in operation 1115. According to an embodiment of the present disclosure, the controller 190 may determine whether the second display unit 152 is changed to be open.

When it is determined that the second display unit 152 is changed to be open, the controller 190 may display a content in the second display unit 152 in operation 1116. When the controller 190 determines that the second display unit 152 is open in operation 1113, the controller 190 may perform operation 1116. As illustrated in FIG. 13, when the second display unit 152 is changed to be open, the first display unit 151 and the second display unit 152 may be disposed to not overlap with each other. According to an embodiment of the present disclosure, the first display unit 151 and the second display unit 152 may be provided in an unfolding form. The second display unit 152 may display a mapped content 1331, 1332, and 1333 in a second face (or a second side) 1311 which is the front side (a side that faces a user) when the second display 152 is open. According to an embodiment of the present disclosure, the second display unit 152 may display the mapped content 1331, 1332, and 1333 in the second face 1311 which is opposite to the first face 1211. For example, when a predetermined content, a news content, and a contact content are mapped in the determined location information, the predetermined content 1331, the news content 1332, and the contact information 1333 may be displayed in the second face 1311 of the second display unit 152.

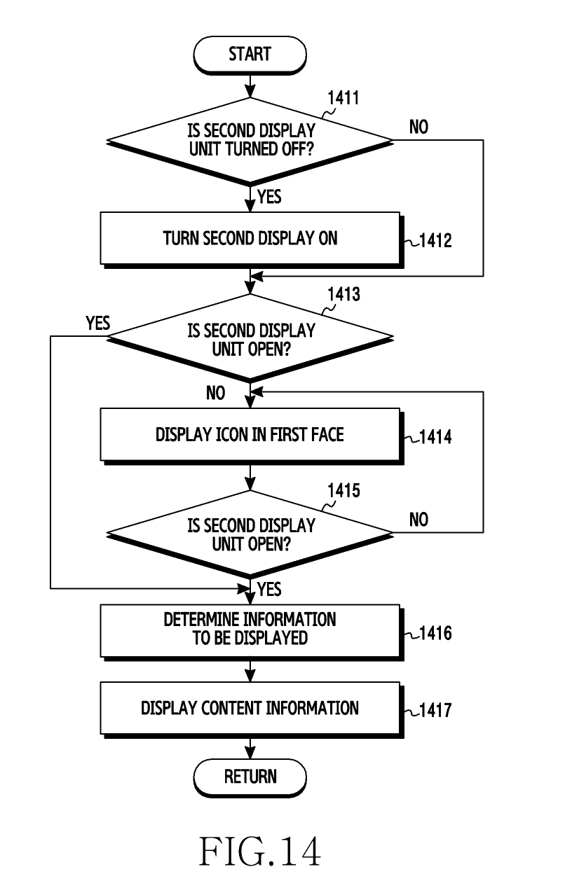

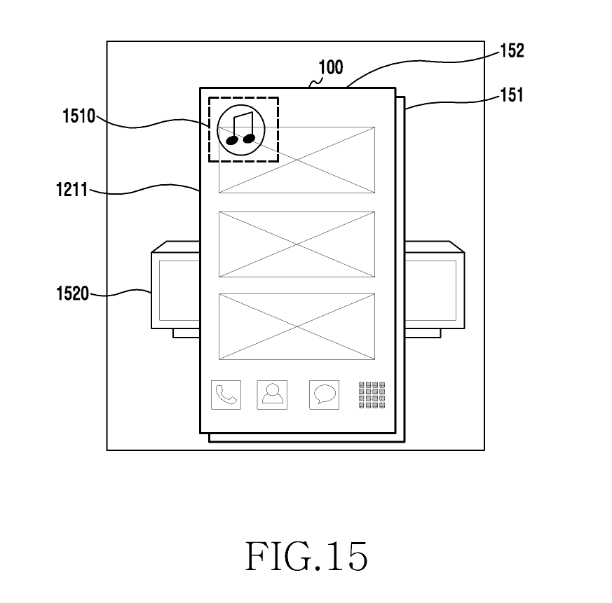

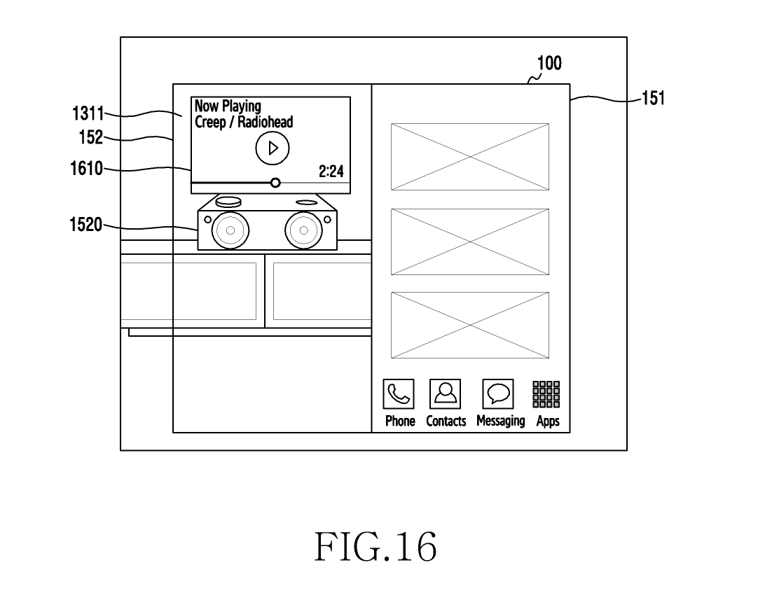

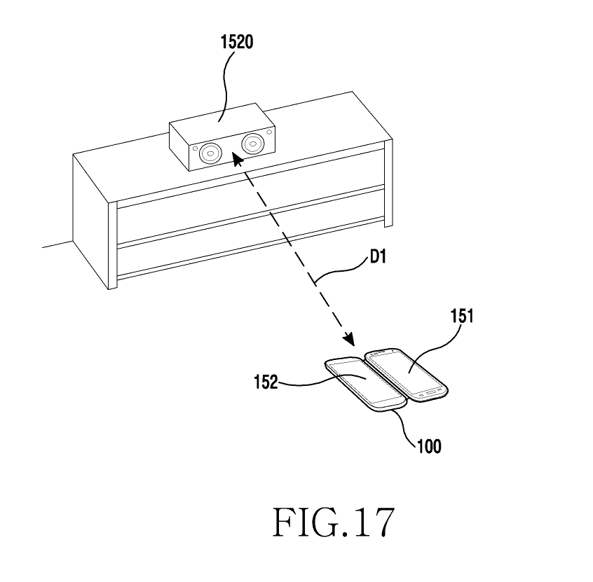

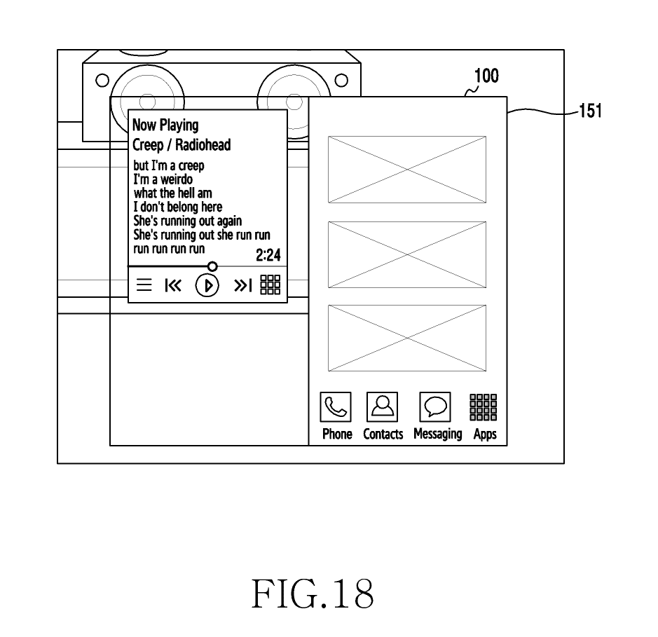

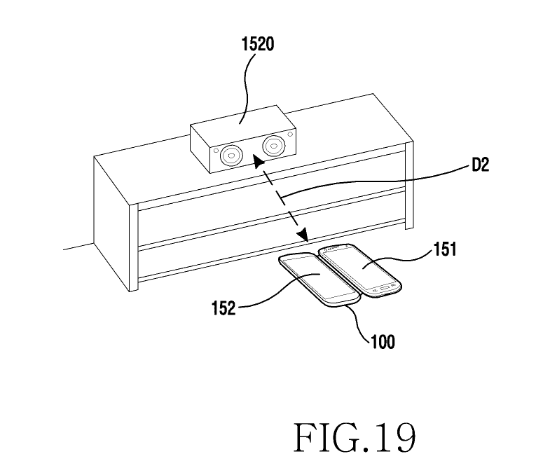

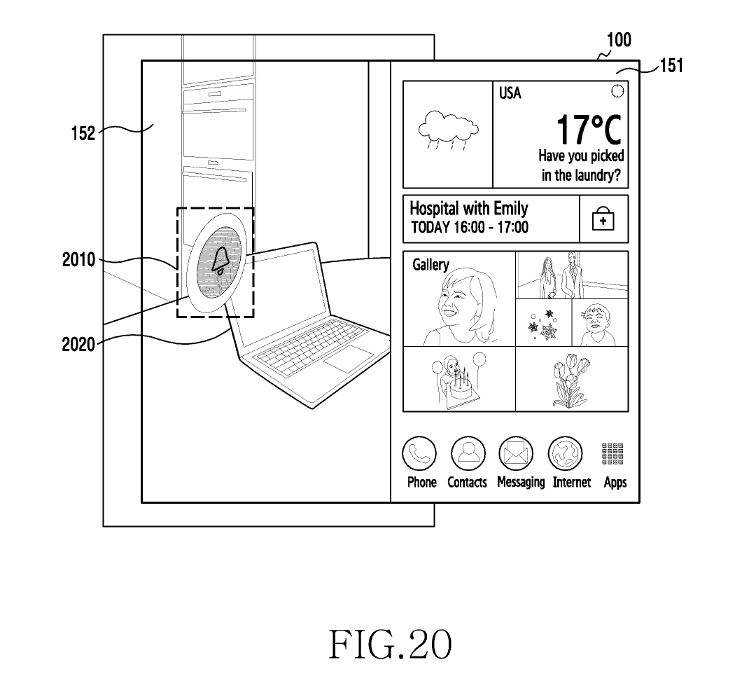

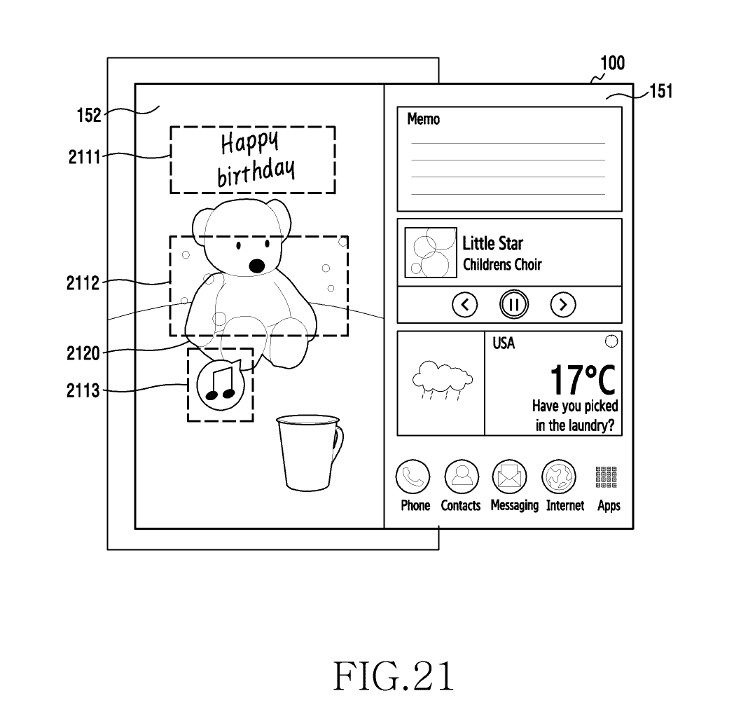

FIG. 14 is a flowchart illustrating the example operation of displaying a content in the second display unit 152, described in FIG. 4. FIGS. 15 and 16 are diagrams illustrating examples of a screen of the electronic device 100 according to various example embodiments of the present disclosure. FIG. 17 is a diagram illustrating an example operation of displaying a content in the second display unit 152. FIG. 18 is a diagram illustrating an example of a screen of the electronic device 100 according to various example embodiments of the present disclosure. FIG. 19 is a diagram illustrating an example operation of displaying a content in the second display unit 152. FIGS. 20 and 21 are diagrams illustrating examples of a screen of the electronic device 100 according to various example embodiments of the present disclosure. FIGS. 14 to 20 illustrate an example in which a content exists that is mapped onto location information determined based on the location of the electronic device 100 and a candidate object capable of performing short-range communication.

As illustrated in FIG. 14, the controller 190 may determine whether the second display unit 152 is turned off in operation 1411.

When it is determined that the second display unit 152 is turned off, the controller 190 may change the second display unit 152 to be turned on in operation 1412. According to an embodiment of the present disclosure, the controller 190 may activate the second display unit 152 in operation 1412.

The controller 190 may determine whether the second display unit 152 is open in operation 1413. When it is determined that the second display unit 152 is not open in operation 1413, the controller 190 displays an icon in a first face of the second display unit 152 in operation 1414. According to an embodiment of the present disclosure, as illustrated in FIG. 15, when the second display unit 152 is closed, as opposed to being open, the first display unit 151 and the second display unit 152 may be disposed to overlap with each other. Since the second display unit 152 is transparent, even when the second display unit 152 is closed, a user may determine various contents 1501, 1502, and 1503 displayed in the first display unit 151. The second display unit 152 may display at least one icon 1510 which indicates a mapped content exists, in the first face 1211 which is the front side when the second display unit 152 is closed. For example, when a music content is mapped onto location information that is determined based on the location of the electronic device 100 and an object 1520 that is capable of performing short-range communication, the controller 190 may display an icon 1510 that indicates the music content is mapped in the first face 1211 of the second display unit 152. The object 1520 capable of performing short-range communication may be an electronic device, for example, a Bluetooth audio device or the like.

The controller 190 may determine whether the second display unit 152 is open in operation 1415. According to an embodiment of the present disclosure, the controller 190 may determine whether the second display unit 152 is changed to be open.

When it is determined that the second display unit 152 is changed to be open, the controller 190 may determine information to be displayed in the second display unit 152 in operation 1416. This may be determined by determining the distance between the object 1520 and the electronic device 100. The controller 190 may determine the distance between the object 1520 and the electronic device 100 based on a signal strength. For example, the controller 190 may determine that the distance between the object 1520 and the electronic device 100 becomes closer as the signal strength of the object 1520 becomes higher. Alternatively, when the controller 190 determines that the signal strength of the object 1520 is less than a threshold value, the controller 190 may determine that the distance between the object 1520 and the electronic device 100 is distant. According to various embodiments of the present disclosure, when the controller 190 determines that the signal strength of the object 1520 is greater than a threshold value, the controller 190 may determine that the distance between the object 1520 and the electronic device 100 is close. The controller 190 may change the level or the contents of a content displayed in the second display unit 152 based on the distance between the determined object 1520 and the electronic device 100. For example, as illustrated in FIGS. 16 and 17, when the controller 190 determines that the distance (D1) between the electronic device 100 and the object 1520 is distant based on a signal strength of the object 1520, the controller 190 determines to display only a representative item or representative contents associated with a music content 1610 in the second display unit 152 in operation 1416. The controller 190 displays the determined content in operation 1417. According to an embodiment of the present disclosure, the controller 190 may display only a representative item or representative contents associated with the music content 1610 in the second display unit 152.

As another example, as illustrated in FIGS. 18 and 19, when the controller 190 determines that the distance (D2) between the electronic device 100 and the object 1520 is close based on a signal strength of the object 1520, the controller 190 determines to display detailed items or detailed contents associated with the music content 1610 in the second display unit 152 in operation 1416. The controller 190 displays the determined content in operation 1417. According to an embodiment of the present disclosure, the controller 190 may display detailed items or extended contents associated with the music content 1610 in the second display unit 152.

As illustrated in FIG. 20, when an object capable of performing communication is a notebook 2020, and a content exists that is mapped onto the location of the electronic device 100 and a communication address of the notebook 2020, the controller 190 may display a mapped content 2010 in the second display unit 152 in operation 1417. According to various embodiments of the present disclosure, when a plurality of candidate objects exist and a plurality of contents mapped onto the plurality of candidate objects exist, all of them are displayed in operation 713 of FIG. 7. According to various embodiments of the present disclosure, the second display unit 152 is embodied to be transparent, and thus, realism may be maximized. For example, when the notebook 2020 is projected onto the second display unit 152 by the line of vision of a user, the user may also determine a mark indicating that a content exists that is mapped onto the corresponding notebook 2020, and thus, a user's experience may be extended. Therefore, the user may implement a realistic user interface that is capable of determining mapped information together with a corresponding object through the second display unit 152.

FIG. 21 illustrates an example in which a content exists that is mapped onto location information determined based on the location of the electronic device 100 and an object that is a parsed image. As illustrated in FIG. 21, when the object 2120 is a parsed image that is obtained from a subject, and a content exists that is mapped onto the object 2120, the controller 190 may display the mapped content 2111, 2112, and 2113 in operation 1417. According to various embodiments of the present disclosure, when a plurality of mapped contents 2111, 2112, and 2113 exist, the controller 190 may display information associated with the plurality of mapped contents 2111, 2112, and 2113 in the second display unit 152. For example, when contents mapped onto a parsed image that is obtained based on the location of the electronic device 100 and an object 2120 of a teddy bear are the memo content 2111 “Happy birthday”, the design content 2112, and the music content 2113, the controller 190 may display all of the contents.

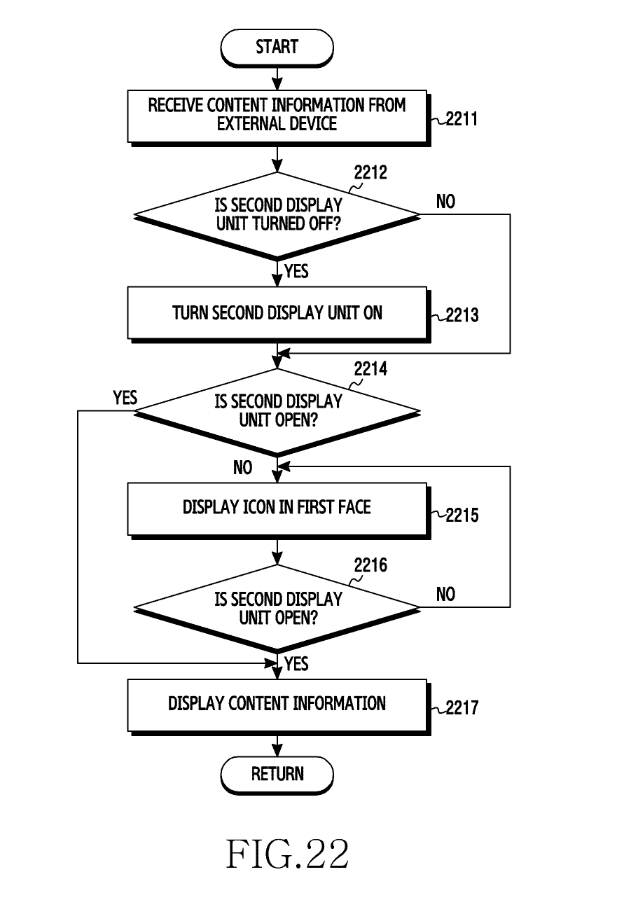

FIG. 22 is a flowchart illustrating the example operation of displaying a content in the second display unit 152, described in FIG. 4. FIGS. 23 to 29 are diagrams illustrating examples of a screen of the electronic device 100 according to various example embodiments of the present disclosure. FIGS. 22 to 29 are diagrams illustrating an example in which a content that is mapped onto an external device exists.

As illustrated in FIG. 22, the controller 190 may receive a content from an external device 2301 in operation 2211. That is, the external device 2301 may store a mapped content, and may frequently or periodically transmit a signal to surroundings. When the electronic device 100 receives a signal from the external device 2301, and transmits a feedback to the external device 2301, the external device 2301 may determine that a target to which a stored content is to be transmitted exists. The external device 2301 transmits the stored content to the determined electronic device 100, and the controller 190 receives the stored content from the external device 2301 in operation 2211. For example, as illustrated in FIG. 23, in an example in which the external device 2301 is prepared in a predetermined space of a house, when the electronic device 100 is disposed nearby the predetermined space of the house, the controller 190 may receive the stored content from the external device 2301.

According to various embodiments of the present disclosure, operations 2212, 2213, 2214, 2215, and 2216 may correspond to operations 1111, 1112, 1113, 1114, and 1115, respectively. Accordingly, detailed descriptions in association with operations 2212, 2213, 2214, 2215, and 2216 will be omitted.

The controller 190 may display a content in the second display unit 152 in operation 2217. For example, as illustrated in FIG. 23, the controller 190 may display, in the second display unit 152, a content received from an external device that is prepared in a predetermined space of a house. For example, in an example in which the external device 2301 is installed on the wall of a house, when the electronic device 100 approaches the wall, the second display unit 152 may display content 2311 and 2312 information. The content 2311 and 2312 may be a photo content of a family who shares the space of the house. Therefore, the photos of family members are mapped onto the external device 2301 and the photos of the family members may be shared through the external device 2301.

When a content is received from the external device 2301 and is displayed, the operation of determining the location information, corresponding to operation 411 of FIG. 4, may be omitted. According to various embodiments of the present disclosure, in the operation of determining the location information which corresponds to the operation 411 of FIG. 4, only the directionality of the electronic device 100 in association with the location of the electronic device 100 may be considered. According to an embodiment of the present disclosure, in operation 411, the controller 190 determines only the directionality of the electronic device 100, such as the direction in which the electronic device 100 faces, the point of compass, the rotation angle, and the like that is detected through the sensor unit 160. By taking into consideration the determined directionality of the electronic device 100, the controller 190 may determine the inclination, the direction, the size, or the like of a content 2311 and 2312 that is display in the second display unit 152.

The form of the displayed content 2311 and 2312 may change based on the directionality of the electronic device 100, and thus, user interaction may be extended. Also, the second display unit 152 is embodied to be transparent, and thus, realism may be maximized. According to an embodiment of the present disclosure, when the wall of a house where the external device 2301 is disposed to is projected onto the second display unit 152, the corresponding wall and a mapped content are determined together in the second display unit 152, user experience may be extended. Therefore, a realistic user interface may be embodied through the second display unit 152, which induces the user to feel as if the content is displayed on the corresponding wall.

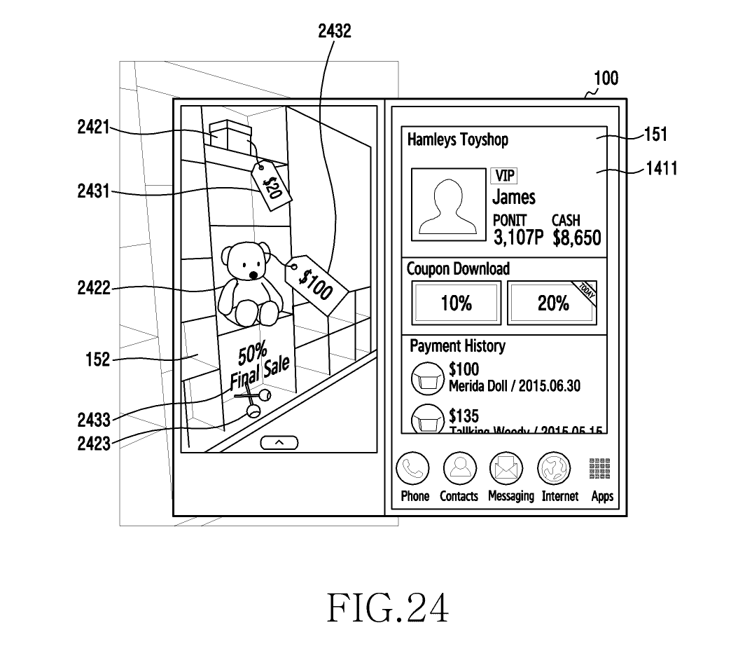

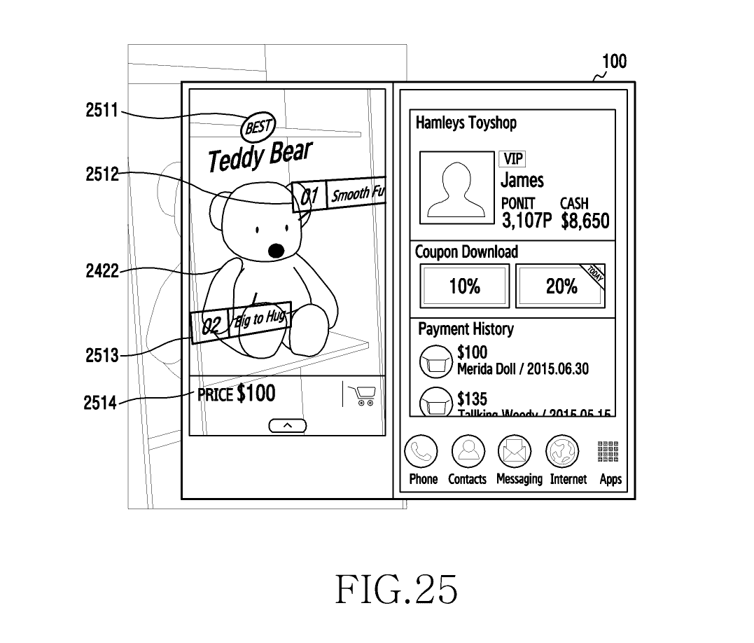

As illustrated in FIGS. 24 and 25, when an external device is prepared in a shop, and a content associated with the shop is mapped onto the external device, the electronic device 100 of a user who visits the shop may display the mapped content. According to an embodiment of the present disclosure, the controller 190 may display a content associated with the shop through the external device, without a separate application. For example, the controller 190 of the electronic device 100 that is located in the shop may be provided with information associated with the shop from the external device of the shop (e.g., the reserved points or the expenditure in the corresponding shop, coupons available in the corresponding shop, the details of expenditure in the corresponding shop, or the like). According to various embodiments of the present disclosure, the information associated with the shop may be unique information associated with a user of the electronic device 100, and may be provided when the controller 190 transmits, to the external device, unique identification information of the electronic device 100. The controller 190 may display the information associated with the shop in the first display unit 151. According to an embodiment of the present disclosure, by providing determined location information to the external device, the electronic device 100 may receive a content associated with the corresponding location information from the external device. The controller 190 may display the content in the second display unit 152. For example, the controller 190 may display price information 2431, 2432, or the like of a product 2421 and 2422 that is displayed in the shop, in the second display unit 152 through the external device. According to various embodiments of the present disclosure, the controller 190 may display discount information 2433 of a product 2423 that is displayed in the shop, in the second display unit 152 through the external device. According to various embodiments of the present disclosure, the second display unit 152 is embodied to be transparent, and thus, realism may be maximized. For example, when the product displayed in the shop is projected onto the second display unit 152 by the line of vision of a user, the corresponding product and the content associated with the corresponding product may be determined together in the second display unit 152, and thus, a user's experience may be extended. Therefore, a realistic user interface may be embodied through the second display unit 152, which induces the user to feel as if the content is displayed on the corresponding product. Also, a smart city infrastructure may be established.

Referring to FIG. 25, the external device determines whether the electronic device 100 is close to a displayed product based on determined location information of the electronic device 100, and provides a content that is different based on the distance between the electronic device 100 and the displayed product. For example, when it is determined that the electronic device 100 is close to the displayed product 2422 based on the determined location information of the electronic device 100, the controller 190 of the electronic device 100 may be provided with an extended content 2511, 2512, and 2513 associated with the displayed product 2422 or an extended function 2514, from the external device.

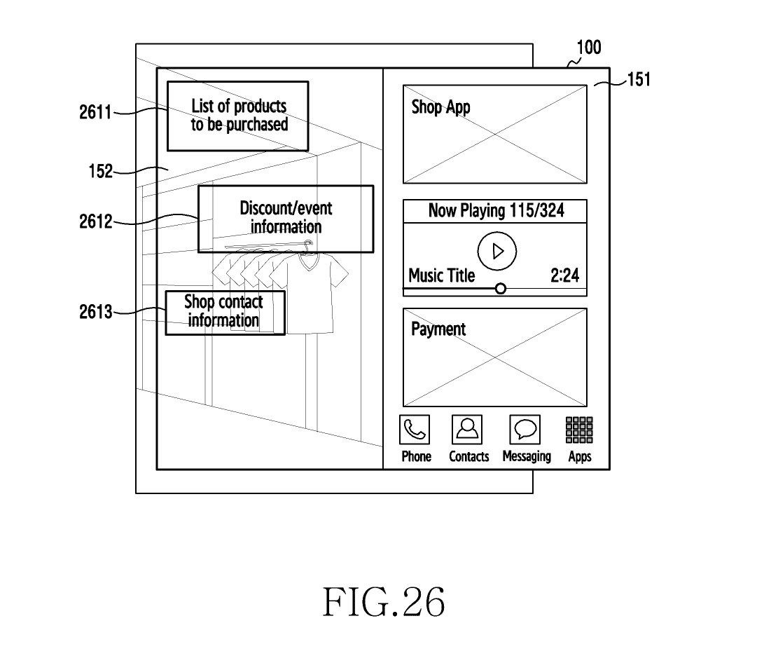

According to various embodiments of the present disclosure, as illustrated in FIG. 26, the controller 190 may display a content mapped onto the electronic device 100 and a content received from an external device together, in the second display unit 152. For example, when a content (e.g., a list of products to be purchased 2611) exists that is mapped onto the location information (e.g., the location of a shop) of the electronic device 100, the controller 190 may display the list of products to be purchased 2611 in the second display unit 152, based on the determined location information. According to various embodiments of the present disclosure, the controller 190 may receive a content (e.g., discount/event information or shop contact information) 2612 and 2613 provided from an external device of a shop, and may display the same.

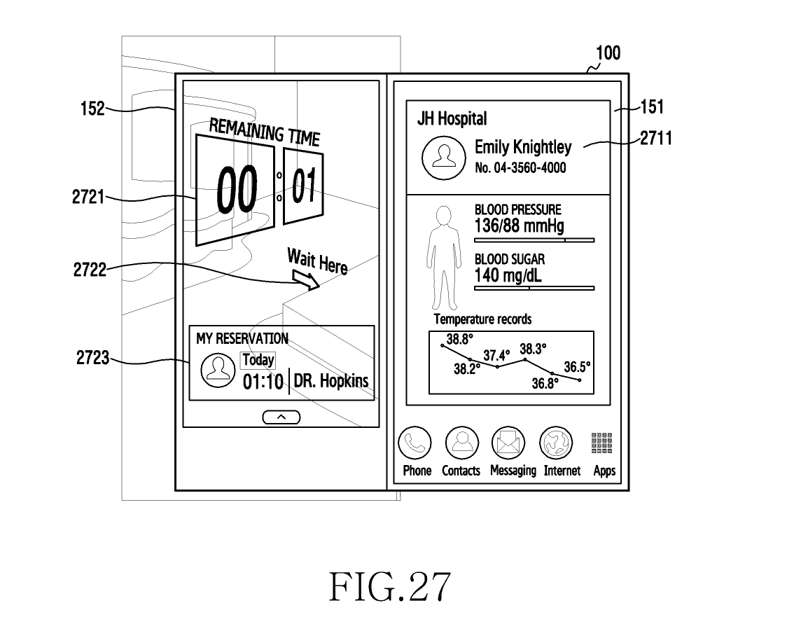

According to various embodiments of the present disclosure, as illustrated in FIG. 27, the controller 190 may display a mapped content 2721, 2722, and 2733 in the second display unit 152 through external devices located in various places. For example, when an external device is installed in a hospital and a content associated with the hospital is mapped onto the external device, the electronic device 100 of a user who visits the hospital may display the mapped content. According to an embodiment of the present disclosure, the controller 190 may display a content associated with the hospital through the external device, without a separate application associated with the corresponding hospital. For example, the controller 190 of the electronic device 100 of the user who visits the hospital may be provided with information associated with the hospital (e.g., a blood pressure, a blood sugar, a body temperature, or the like, which is measured at the corresponding hospital) from the external device of the hospital. According to various embodiments of the present disclosure, the information associated with the hospital may be unique information associated with a user of the electronic device 100, and may be provided when the controller 190 transmits, to the external device, unique identification information of the electronic device 100. According to various embodiments of the present disclosure, the information associated with the hospital may be information that recommends an application of the corresponding hospital or an application associated with health. The controller 190 may display the information associated with the hospital in the first display unit 151. According to an embodiment of the present disclosure, the controller 190 may receive a content associated with the corresponding location information from the external device by providing the determined location information to the external device. The controller 190 may display the content in the second display unit 152. For example, the controller 190 may display a waiting time for medical treatment 2721, a waiting position 2722, or a reservation state 2723 or the like in the second display unit 152 through the external device. According to various embodiments of the present disclosure, the second display unit 152 is embodied to be transparent, and thus, realism may be maximized. For example, when the space of a corresponding place is projected onto the second display unit 152 by the line of vision of a user, the corresponding place and a content associated with the corresponding place may be determined together in the second display unit 152, and thus, a user's experience may be extended. Therefore, a realistic user interface may be embodied through the second display unit 152, which induces the user to feel as if the content is displayed in the corresponding place.

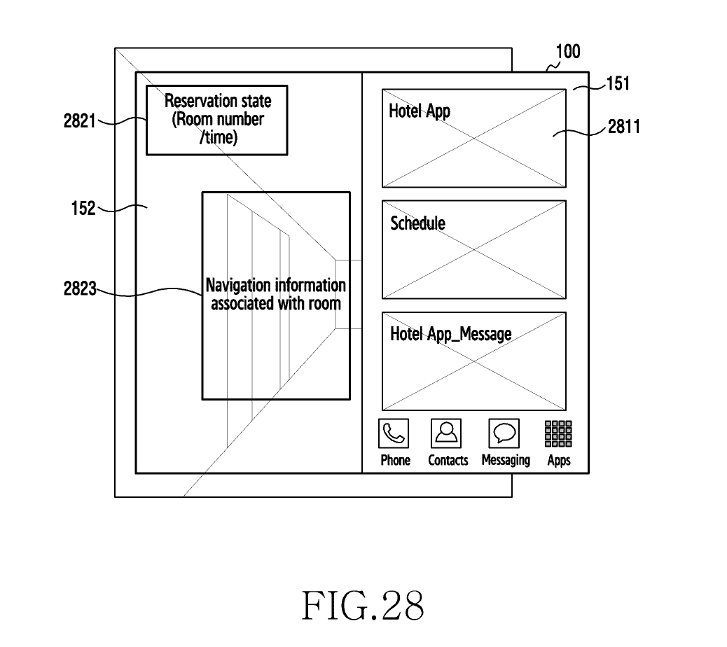

According to various embodiments of the present disclosure, as illustrated in FIG. 28, the controller 190 may display a mapped content 2821 and 2823 in the second display unit 152 through external devices located in various places. For example, when an external device is installed in a hotel and a content associated with the hotel is mapped onto the external device, the electronic device 100 of a user who visits the hotel may display the mapped content. For example, the controller 190 of the electronic device 100 of the user who visits the hotel may be provided with an application 2711 associated with the hotel from the external device of the hotel. The controller 190 may display, in the first display unit 151, the application 2711 associated with the hotel. According to various embodiments of the present disclosure, the controller 190 may be provided with user's unique information (e.g., a reservation state) 2821 associated with the hotel by transmitting unique identification information of the electronic device 100 to the external device, and may display the unique information in the second display unit 152. According to various embodiments of the present disclosure, by providing determined location information to the external device, the controller 190 may receive a content associated with the corresponding location information from the external device. For example, the controller 190 may display navigation information 2823 or the like associated with a reserved room in the second display unit 152 through the external device.

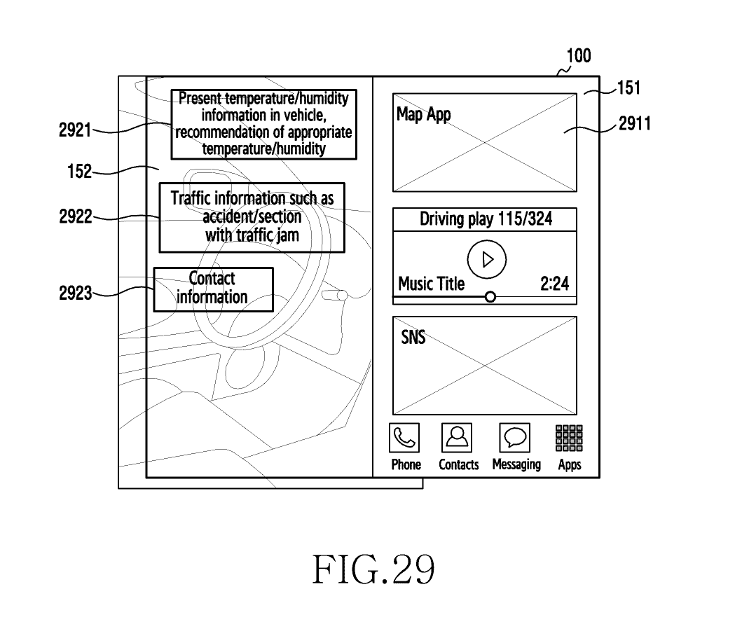

According to various embodiments of the present disclosure, as illustrated in FIG. 29, when an external device is included in a transportation means such as a vehicle, and a content associated with a vehicle or traffic is mapped onto the external device, the electronic device 100 of a user who rides in the vehicle may display the mapped content. For example, the controller 190 of the electronic device 100 of the user who is in the vehicle may be provided with a map application 2911 from the external device of the vehicle. The controller 190 may display the map application 2911 in the first display unit 151. According to various embodiments of the present disclosure, the controller 190 may display a content associated with traffic in the second display unit 152 through the external device, without a separate application. For example, the controller 190 of the electronic device 100 located in the vehicle may be provided with information associated with the vehicle or traffic (e.g., the present temperature and humidity information in the vehicle, the recommendation of an appropriate temperature and humidity, traffic information such as an accident spot, a section of road which has heavy traffic, or the like, contact information, or the like) 2921, 2922, and 2923. According to various embodiments of the present disclosure, the controller 190 may receive, from the external device, the list of family members who share the vehicle, basic vehicle setting information for each family member, destination setting information based on a today's schedule, and the like, and may display the same in the second display unit 152.

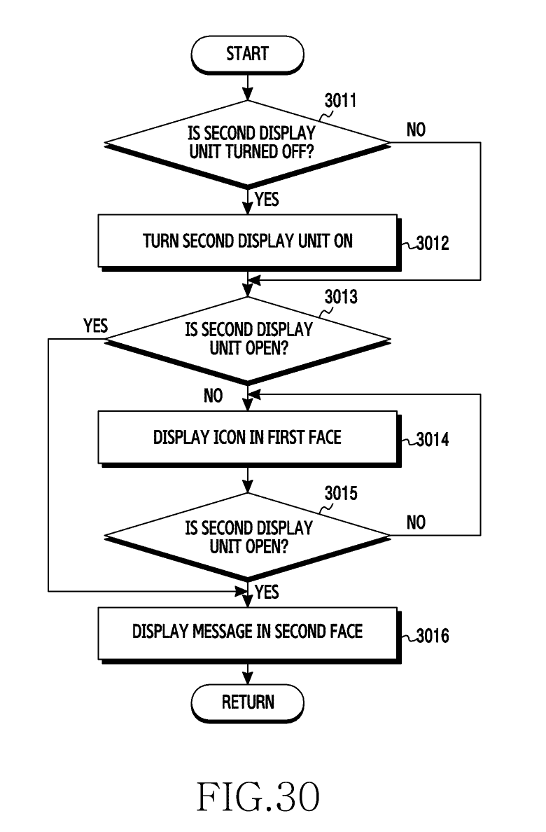

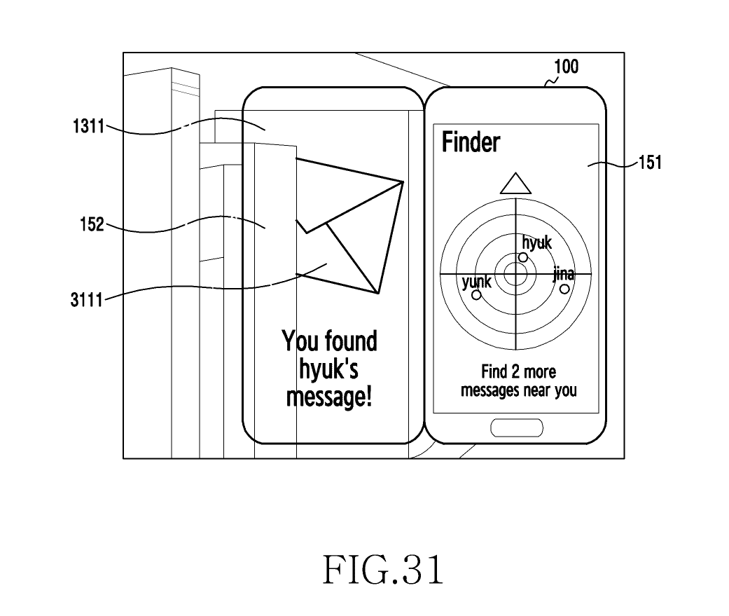

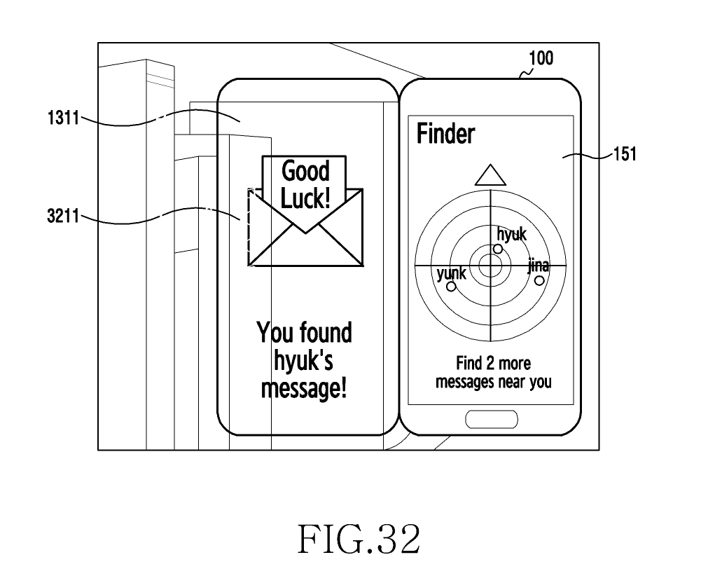

FIG. 30 is a flowchart illustrating the example operation of displaying a content in the second display unit 152, described in FIG. 4. FIGS. 31 and 32 are diagrams illustrating examples of a screen of the electronic device 100 according to various example embodiments of the present disclosure. FIGS. 30 to 32 are diagrams illustrating an example in which a content exists that is mapped onto a message received from the outside.

As described in FIG. 30, operations 3011, 3012, 3013, 3014, and 3015 may correspond to operations 1111, 1112, 1113, 1114, and 1115, respectively.

The controller 190 may display a message 3111 in the second display unit 152 in operation 3016. That is, as illustrated in FIG. 31, the second display unit 152 may display a message 3111 that is mapped onto corresponding location information, in a second face 1311 which is the front side when the second display unit 152 is open. Alternatively, as illustrated in FIG. 32, the second display unit 152 may display contents 3211 of a message that is mapped onto the corresponding location information, in the second face 1311 of the second display unit 152. The first display unit 151 may display a screen associated with the location information to which the message is mapped. According to an embodiment of the present disclosure, the first display unit 151 may display the location information to which the message is mapped, location information of the electronic device 100, and the like. According to various embodiments of the present disclosure, the second display unit 152 is embodied to be transparent, and thus, realistic and emotional communication may be provided. That is, when a message exists that is mapped onto a real space or object, and the corresponding space or the corresponding object is projected onto the second display unit 152, the mapped message is displayed, and thus, a user may be provided with emotional intimacy.

Referring to FIG. 4, the controller 190 may determine whether an input is received in operation 415. The controller 190 may sense whether a user input is received by the first display unit 151 or the second display unit 152 of the electronic device 100. When the controller 190 determines that the input is not received, the method returns to operation 411 and determines location information.

When the controller 190 determines that the input is received, the controller 190 determines whether the received input is an input for mapping a content in operation 416. The input for mapping a content may be set in advance. For example, when an input that is continuously dragged throughout the first display unit 151 and the second display unit 152 is set as an input for mapping a content, the controller 190 determines whether the received input corresponds to the set input in operation 416.

When it is determined that the received input is the input for mapping a content, the controller 190 maps a content onto the determined location information in operation 418. The operation of mapping the content may change based on: an example in which a content is mapped onto location information determined based on the location of the electronic device 100; an example in which a content is mapped onto location information determined through the location of the electronic device 100 and an object capable of performing short-range communication; an example in which a content is mapped onto location information determined through the location of the electronic device 100 and an object which is a parsed image; an example in which a content is mapped onto an external device; and an example in which a content is mapped onto a message.

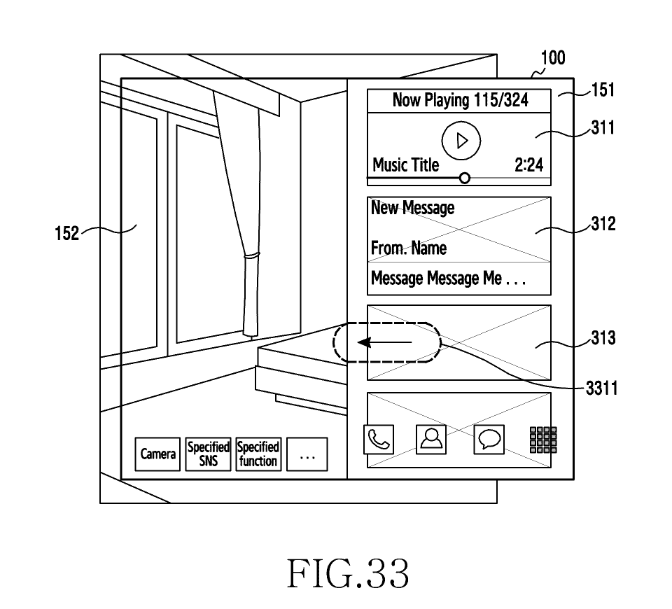

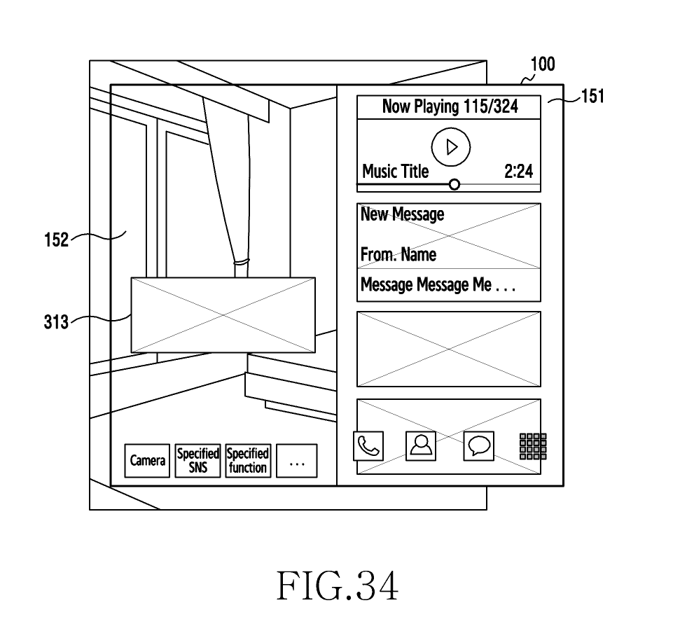

FIGS. 33 and 34 are diagrams illustrating examples of a screen of the electronic device 100 according to various example embodiments of the present disclosure. FIGS. 33 to 34 illustrate an example in which a content is mapped onto location information determined based on the location of the electronic device 100. For example, FIGS. 33 and 34 illustrate an example in which a content is mapped by determining location information based on only the location of the electronic device 100, irrespective of an object.

As illustrated in FIG. 33, when an input 3311 for mapping is received on one out of various contents 311, 312, and 313 displayed in the first display unit 151, the controller 190 may perform a content mapping function. The input 3311 for mapping may be an input that is given on the content 313 selected in the first display unit 151 and is continuously dragged to the second display unit 152. That is, when the input that is given on the first display unit 151 and is released on the second display unit 152, the input may be determined as the input 3311 for mapping. However, the embodiment may not be limited thereto, and the input for mapping a content may be variously set based on a user.

As illustrated in FIG. 34, when the input 3311 for mapping is generated that is given on the first display unit 151 and is released on the second display unit 152, the controller 190 may display the selected content 313 in the second display unit 152. The controller 190 displays the selected content 131 in the second display unit 152, thereby mapping the content and enabling a user to recognize the content. According to an embodiment of the present disclosure, the controller 190 may map the selected content 313 onto the location information determined in operation 411. As described above, in various embodiments of the present disclosure, the determined location information is information that is obtained without taking into consideration an object, and thus, the controller 190 may map the selected content 313 only based on the location of the electronic device 100, which is determined through the GPS receiving unit 120 and/or the sensor unit 160.

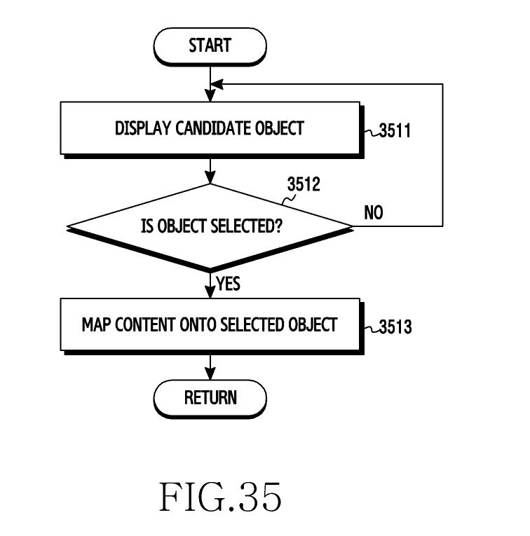

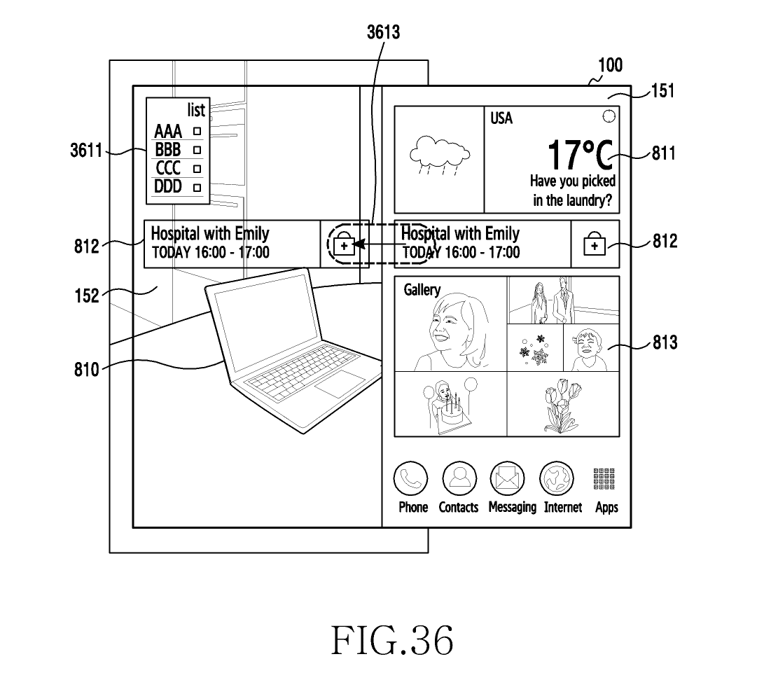

FIG. 35 is a flowchart illustrating the example content mapping operation of FIG. 4. FIGS. 36 to 40 are diagrams illustrating examples of a screen of the electronic device 100 according to various example embodiments of the present disclosure. FIGS. 35 to 37 illustrate an example in which a content is mapped onto location information determined based on the location of the electronic device 100 and an object capable of performing short-range communication.

As illustrated in FIG. 35, the controller 190 displays a candidate object in operation 3511. According to an embodiment of the present disclosure, the controller 190 displays the list output in operation 713 of FIG. 7. For example, as illustrated in FIG. 36, when the controller 190 receives an input 3613 for mapping a content, the controller 190 may display, in the second display unit 152, a content 812 to be mapped and a list 3611 of candidate objects to which a content may be mapped. According to various embodiments of the present disclosure, when a content exists that is mapped onto one out of the objects included in the list of objects, the mapped content may be displayed together in the second display unit 152. As described above, the candidate objects may be objects that are capable of performing short-range communication. Therefore, the list 3611 may include communication addresses of the electronic device 100 or a base station, such as a TV, a PC, a notebook, a Bluetooth speaker, an audio device, or the like which is equipped with a communication module.

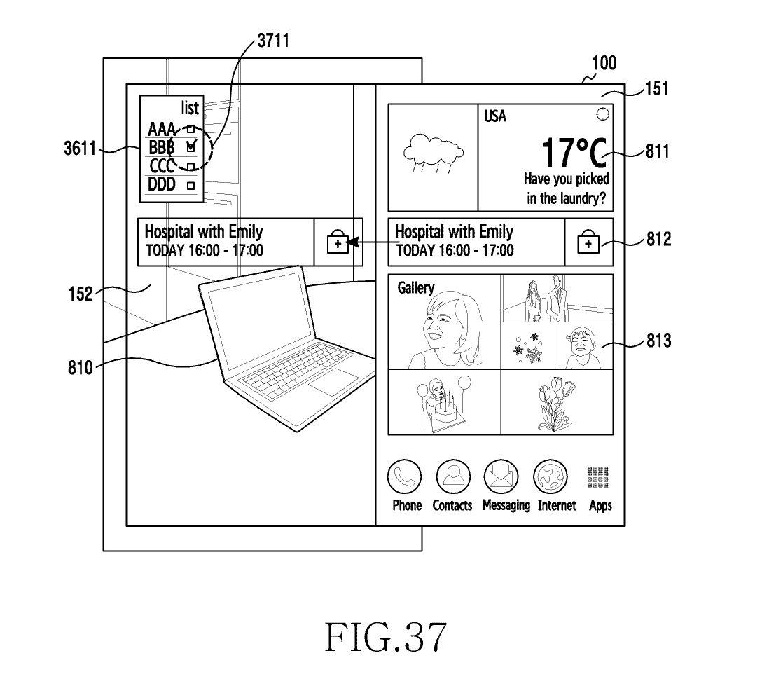

Subsequently, the controller 190 determines whether an object is selected in operation 3512. The controller 190 may determine whether an input 3711 is received that selects one object from the list 3611 displayed in the second display unit 152. For example, as illustrated in FIG. 37, when the input 3711 is received that selects an object having a communication address “BBB” from the list 3611, the controller 190 may display that “BBB” is selected out of the list 3611.

The controller 190 maps a content onto the selected object in operation 3513. According to an embodiment of the present disclosure, the controller 190 maps a content onto location information determined based on the location of the electronic device 100 and the selected object in operation 3513. According to various embodiments of the present disclosure, the second display unit 152 is embodied to be transparent, and thus, realism may be maximized. For example, when the notebook 810, which is an object having a communication address “BBB”, is projected onto the second display unit 152 by the line of vision of a user, a content may be mapped onto the corresponding notebook 810, and thus, a user's experience may be extended. Therefore, a realistic user interface may be embodied by providing a user with emotion that directly maps a content onto the corresponding object 810 that is projected onto the second display unit 152.

FIG. 35 and FIGS. 38 to 40 illustrate an example in which a content is mapped onto location information determined based on the location of the electronic device 100 and an object which is a parsed image.

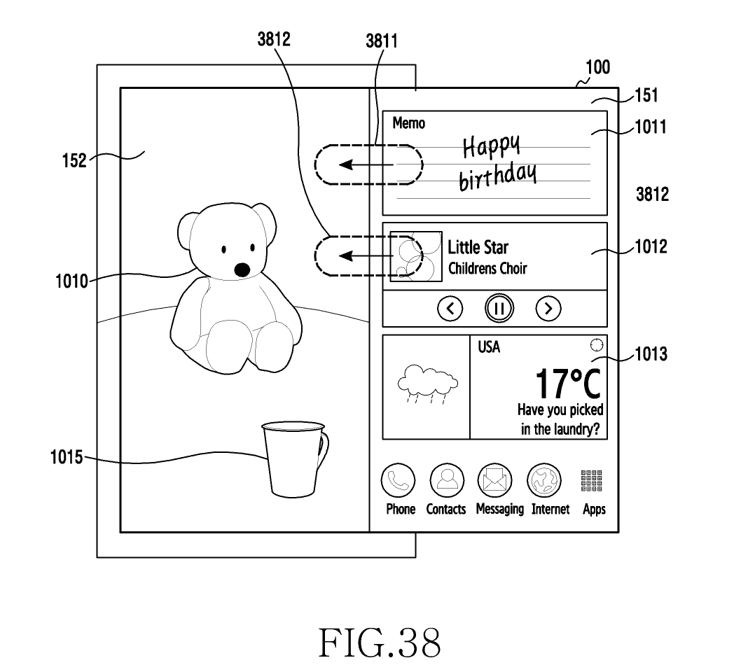

First, as illustrated in FIG. 35, the controller 190 displays a candidate object in operation 3511. According to an embodiment of the present disclosure, the controller 190 displays a parsed image in operation 912 of FIG. 9. For example, as illustrated in FIG. 38, the controller 190 displays a parsed image in the second display unit 152, and receives an input 3811 and 3812 for mapping, which is an input that is given on the first display unit 151 and is released on the second display unit 152. According to various embodiments of the present disclosure, when a content exists that is mapped onto one out of parsed images, the mapped content may be displayed together in the second display unit 152.

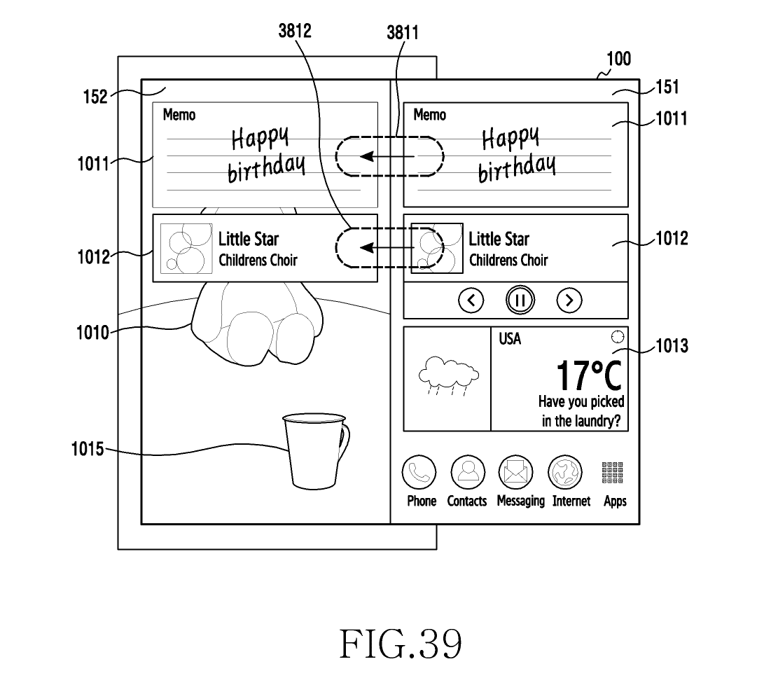

As illustrated in FIG. 39, when an input 3811 and 3812 for mapping is generated, the controller 190 may display a selected content 1011 and 1012 in the second display unit 152. When a plurality of inputs 3811 and 3812 for mapping exist, the controller 190 may determine to map a plurality of contents.

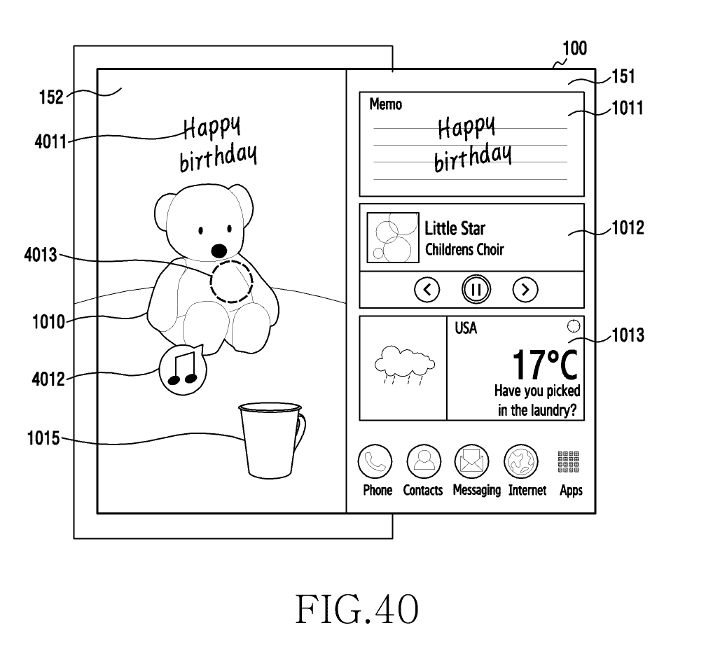

The controller 190 determines whether an object is selected in operation 3512. The controller 190 may determine whether an input 4013 is received that selects one object from the parsed images 1010 and 1015 displayed in the second display unit 152. For example, as illustrated in FIG. 40, when the input 4013 for selecting one image 1010 out of the parsed images 1010 and 1015 is received, the controller 190 may emphasize only the selected image 1010.

The controller 190 maps a content onto the selected object in operation 3513. That is, the controller 190 maps a content onto location information determined based on the location of the electronic device 100 and the selected object in operation 3513. According to various embodiments of the present disclosure, the controller 190 may reprocess mapped contents 4011 and 4012 that are displayed in the second display unit 152, to have a form appropriate for an object, and may display the same. For example, the object 1010 and the mapped contents 4011 and 4012 may be disposed to be in harmony by taking into consideration the size, the form, or the like of the selected object.

According to various embodiments of the present disclosure, the second display unit 152 is embodied to be transparent, and thus, realism may be maximized. For example, when the object 1010, which is a parsed image, is projected onto the second display unit 152 by the line of vision of a user, a content may be mapped onto the corresponding object 1010, and thus, a user's experience may be extended. Therefore, a realistic user interface may be embodied by providing a user with emotion that directly maps a content onto the corresponding object 1010 that is projected onto the second display unit 152.

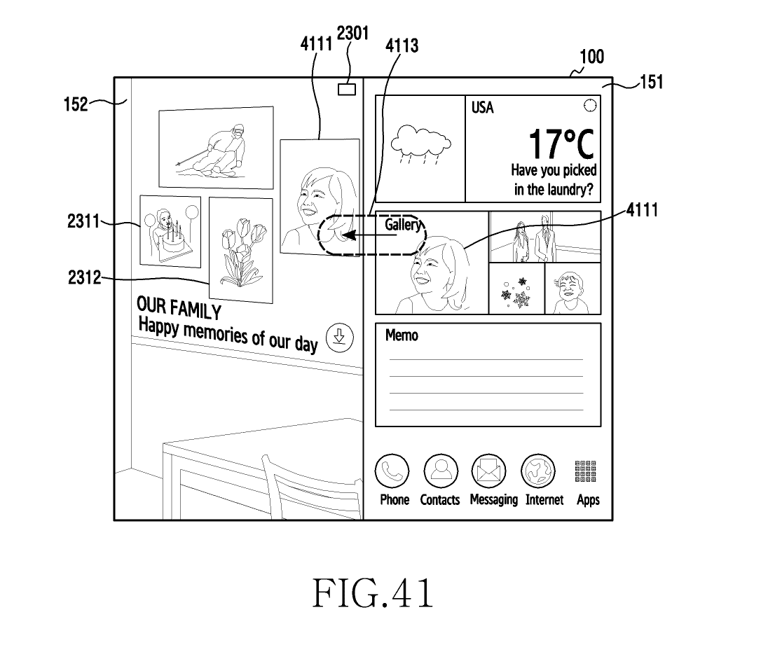

FIGS. 41 to 43 are diagrams illustrating examples of a screen of the electronic device 100 according to various example embodiments of the present disclosure. FIGS. 41 to 43 are diagrams illustrating an example in which a content is mapped onto an external device. As illustrated in FIG. 41, when an input 4113 for mapping is generated, the controller 190 may display a selected content 4111 in the second display unit 152. According to various embodiments of the present disclosure, when contents 2311 and 2312 exist that are mapped in advance onto the external device 2301, the controller 190 may receive the mapped content 2311 and 2312 information from the external device 2301, and may display the same together. That may be displayed in the second display unit 152, as described in FIGS. 22 and 23. The previously mapped contents 2311 and 2312 may be contents that are mapped by the corresponding electronic device 100. According to various embodiments of the present disclosure, the previously mapped contents 2311 and 2312 may be contents that another electronic device that is different from the corresponding electronic device 100 maps onto the external device 2301. The controller 190 may receive a signal from the external device 2301 to which a content may be mapped, and may map a content onto the external device 2301 by transmitting the selected content 4111 information to the external device 2301. According to various embodiments of the present disclosure, when the controller 190 receives a signal from objects capable of performing short-range communication, which has been described in advance, in addition to receiving from the adjacent external device 2301, the controller 190 may output communication addresses of the external device 2301 and the objects together. For example, as described in FIGS. 36 and 37, the controller 190 may output and display the communication addresses of the external device 2301 and the objects, and may receive an input for selecting the external device 2301. According to various embodiments of the present disclosure, the second display unit 152 is embodied to be transparent, and thus, realism may be maximized. For example, when the space of a house where the external device 2301 is disposed is projected onto the second display unit 152 by the line of vision of a user, emotion that maps a content onto the corresponding space may be provided, and thus, a user's experience may be extended. According to various embodiments of the present disclosure, users who share space in a house share contents with each other through the external device 2301, so that the users may be induced to share experiences in the same space and communicate with each other.

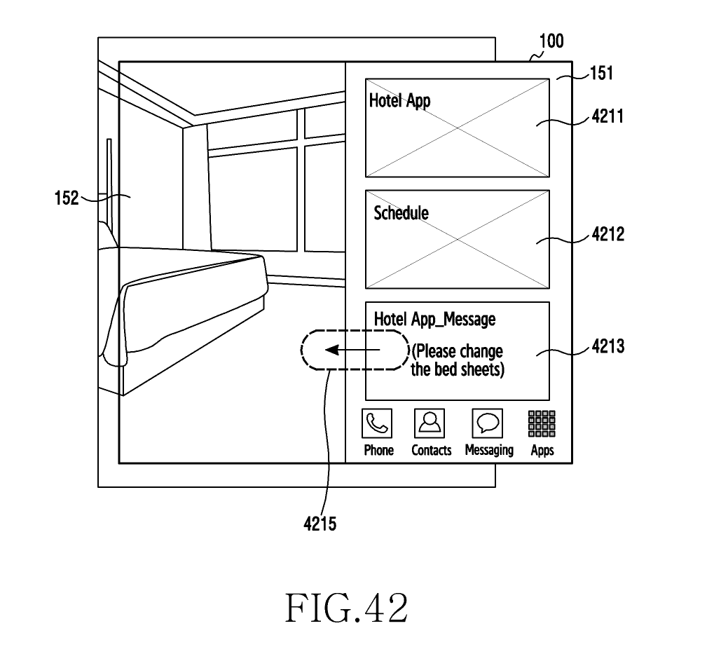

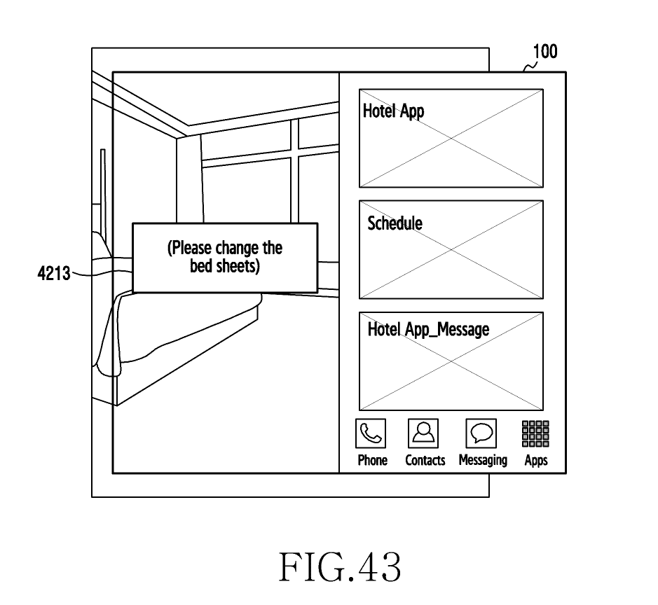

According to various embodiments of the present disclosure, as illustrated in FIGS. 42 and 43, the controller 190 may map a content through external devices in various places. For example, when the external device is installed in a hotel, the electronic device 100 of a user who visits the hotel may map a content onto an external device in a hotel room. As illustrated in FIG. 42, the controller 190 may be provided with an application 4211, 4212, and 4213 that is associated with the hotel, from the external device, may display the same in the first display unit 151, and may receive a user input provided on at least one out of the applications. For example, the controller 190 may receive a request (“please change the bed sheets”) that is input by a user through the message application 4213. According to various embodiments of the present disclosure, when the controller 190 receives an input 4215 for mapping a content, the controller 190 may display the selected content 4213 in the second display unit 152 as illustrated in FIG. 43. The controller 190 may map, onto the external device installed in the hotel room, the content 4213 displayed in the second display unit 152. The external device may be embodied to operate in connection with a hotel server, and a user may transfer a request without directly asking a hotel manager. According to various embodiments of the present disclosure, the second display unit 152 is embodied to be transparent, and thus, realism may be maximized. For example, when a space in the hotel is projected onto the second display unit 152 by the line of vision of a user, emotion that maps a content onto the corresponding space may be provided, and thus, a user's experience may be extended. According to an embodiment of the present disclosure, content mapping may enable a user to simply and conveniently deliver a request to a hotel manager. According to various embodiments of the present disclosure, as illustrated in FIG. 28, the electronic device 100 of a hotel manager who visits a corresponding hotel room may display a content mapped by a guest and may readily recognize a request from the guest, as illustrated in FIG. 28.

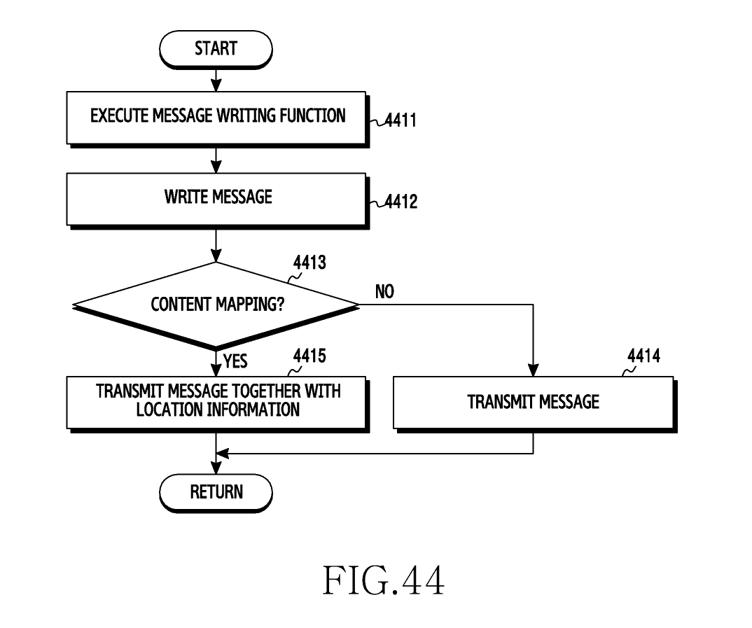

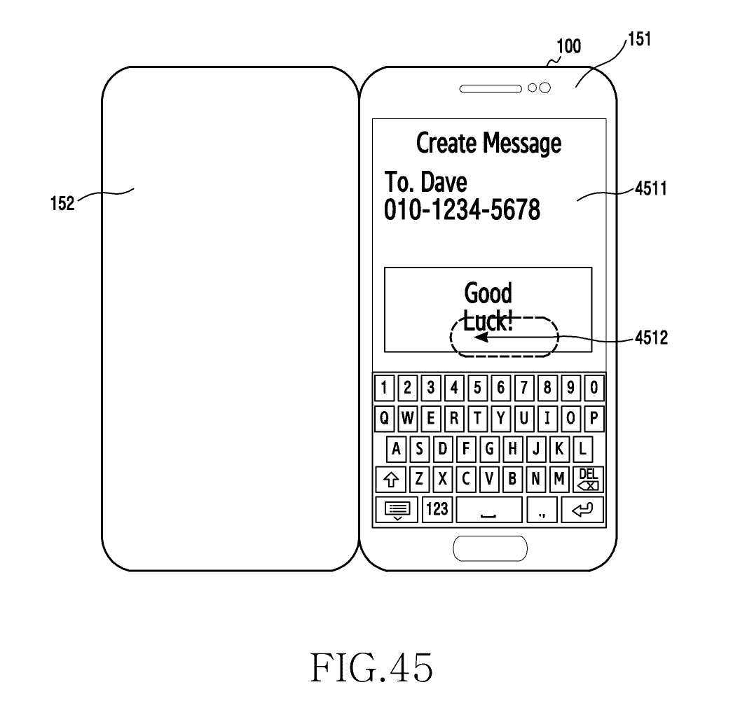

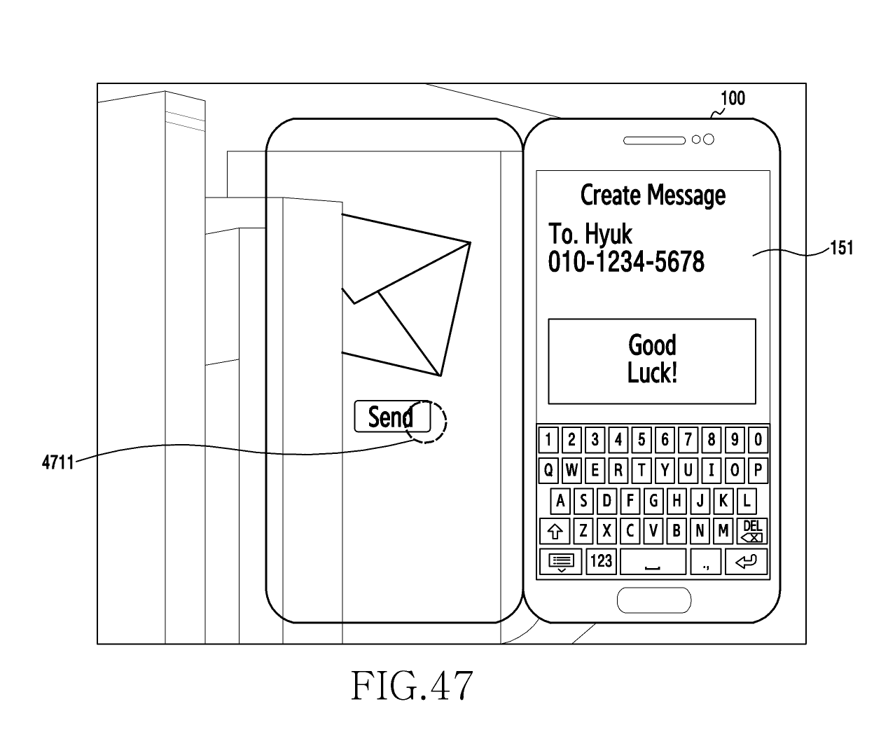

FIG. 44 is a flowchart illustrating the example content mapping operation of FIG. 4. FIGS. 45 to 48 are diagrams illustrating examples of a screen of the electronic device 100 according to various embodiments of the present disclosure. FIGS. 44 to 48 are diagrams illustrating an example in which a content is mapped onto a message.

The controller 190 may execute a message writing function in operation 4411. That is, as illustrated in FIG. 45, the controller 190 may display a message writing application 4511 in the first display unit 151.

The controller 190 may receive a message writing input in operation 4412, and may display the input contents in the message writing application 4511. For example, the controller 190 may receive an input “Good luck!”, and may display the same in the first display unit 151.

The controller 190 may determine whether the received input is an input 4512 for mapping a content in operation 4413.

When the received input is not the input for mapping a content, the controller 190 may transmit a message in operation 4414. According to an embodiment of the present disclosure, the controller 190 may not map a content, and may transmit only a message.

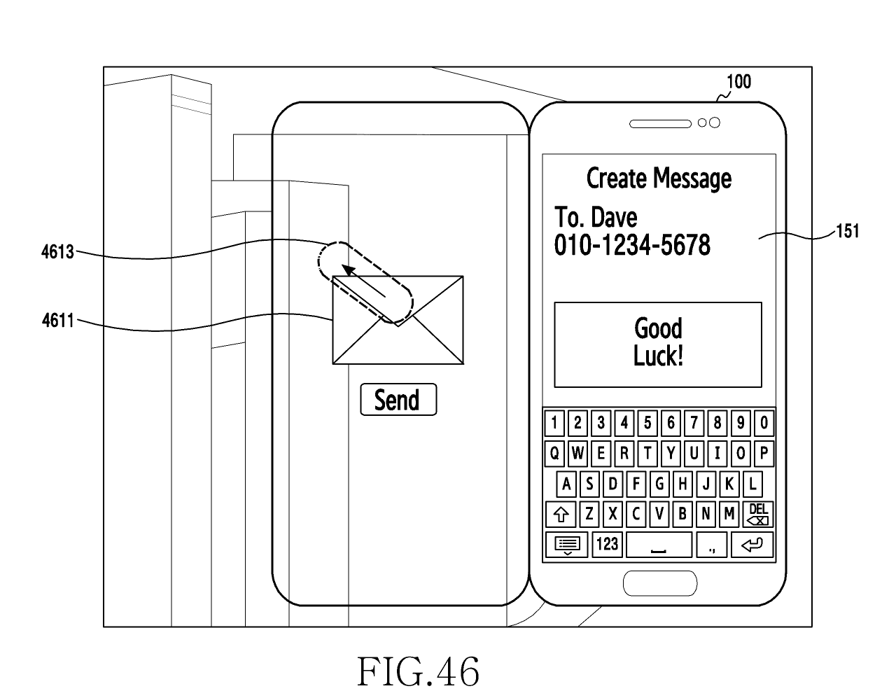

When the received input is the input 4512 for mapping a content, the controller 190 may display a message icon 4611 in the second display unit 152, as illustrated in FIG. 46. The controller 190 may further receive an input 4613 for adjusting the location of a message icon 4611 in the second display unit 152. Through the input 4613, the location of the message icon 4611 in the second display unit 152 may be adjusted. According to various embodiments of the present disclosure, the second display unit 152 is embodied to be transparent, and thus, realism may be maximized. For example, when a background is projected onto the second display unit 152 by the line of vision of a user, emotion, such as leaving a message in the corresponding background, may be provided. For example, when a bookcase in a library is projected onto the second display unit 152, a user's experience, such as putting a message between books, may be provided.

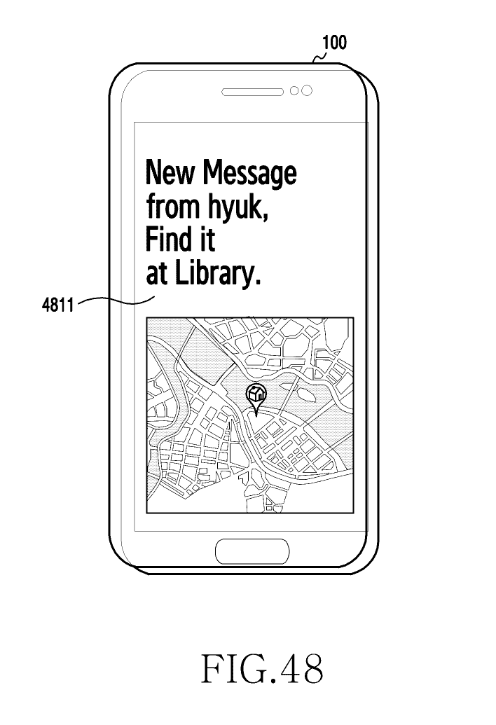

The controller 190 may receive an input 4711 for transmission, and may transmit a message together with determined location information in operation 4415. When the message is transmitted, the controller 190 may perform transmission to enable the electronic device 100 of a partner to display place information where the message is mapped. Accordingly, as illustrated in FIG. 48, the electronic device 100 of the partner that receives the message may display information indicating that a message is received and the place information where the message is mapped. According to various embodiments of the present disclosure, the electronic device 100 of the partner may determine the contents of the received message in only the place where the message is mapped. According to various embodiments of the present disclosure, there may be provided a communication service that leaves a digital message in a real space.

When it is determined that the received input is not an input for mapping a content in operation 416 of FIG. 4, the controller 190 may perform a corresponding function in operation 417. According to an embodiment of the present disclosure, the controller 190 may perform a function associated with the received input.

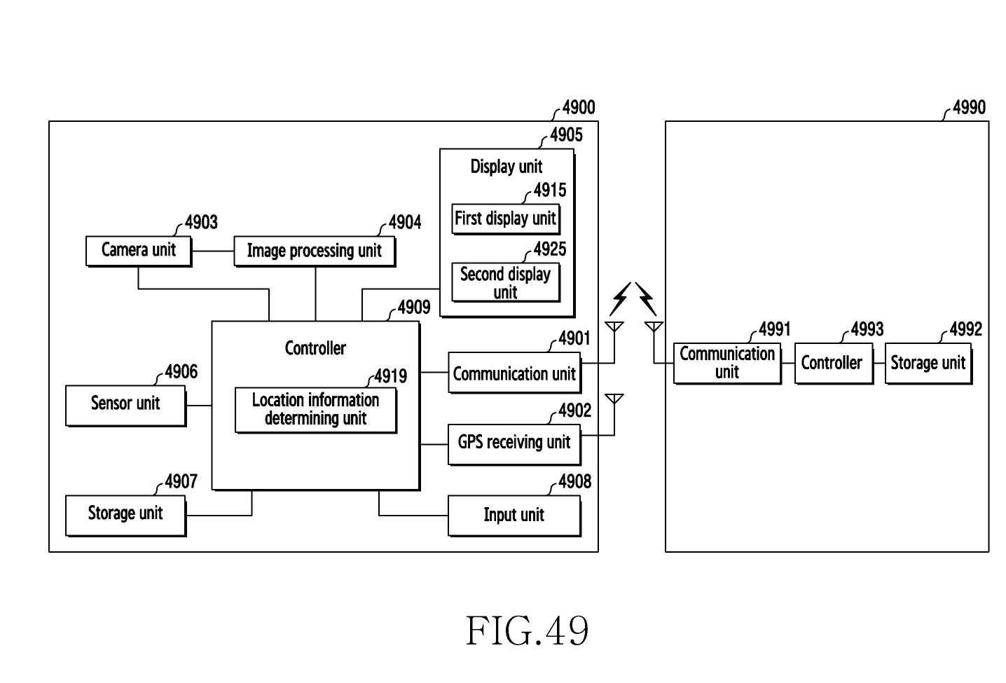

FIG. 49 is a block diagram illustrating an example electronic device and an external device according to various example embodiments of the present disclosure.

As illustrated in FIG. 49, according to various embodiments of the present disclosure, an electronic device 4900 includes a communication unit (e.g., including communication circuitry) 4901, a GPS receiving unit (e.g., including GPS receiving circuitry) 4902, a camera unit (e.g., including a camera) 4903, an image processing unit (e.g., including image processing circuitry) 4904, a display unit (e.g., including at least one display) 4905, a sensor unit (e.g., including at least one sensor or sensing circuitry) 4906, a storage unit 4907, an input unit (e.g., including input circuitry) 4908, and a controller 4909. According to various embodiments of the present disclosure, the elements of the electronic device 4900 may be similar to the corresponding elements in the above described embodiments, and thus, detailed descriptions thereof will be omitted.

According to various embodiments of the present disclosure, an external device 4990 may include a communication unit 4991, a controller 4993, and a storage unit 4992. The communication unit 4991 of the external device 4990 may frequently or periodically transmit a signal. The external device 4990 transmits a signal to determine whether the electronic device 4900 exists in surroundings. According to an embodiment of the present disclosure, the communication unit 4991 of the external device 4990 may receive a signal from the electronic device 4900. For example, when the electronic device 4900 exists around the external device 4990, the communication unit 4991 may receive a signal from the electronic device 4900. The communication unit 4991 may transmit a mapped content onto the electronic device 4900 by request of the electronic device 4900.

The storage unit 4992 of the electronic device 4990 may store a mapped content. The storage unit 4992 of the external device 4990 may store both location information and a content obtained from the electronic device 4900. The storage unit 4992 may map a content onto location information.

The controller 4993 may control general operations of the external electronic device 4990. When the controller 4993 receives a signal from the electronic device 4900, the controller 4993 may determine whether a content corresponding to the electronic device 4900 exists through the storage unit 4992. According to various embodiments of the present disclosure, when the controller 4993 receives location information together from the electronic device 4900, the controller 4993 may determine whether a content corresponding to the received location information exists through the storage unit 4992.

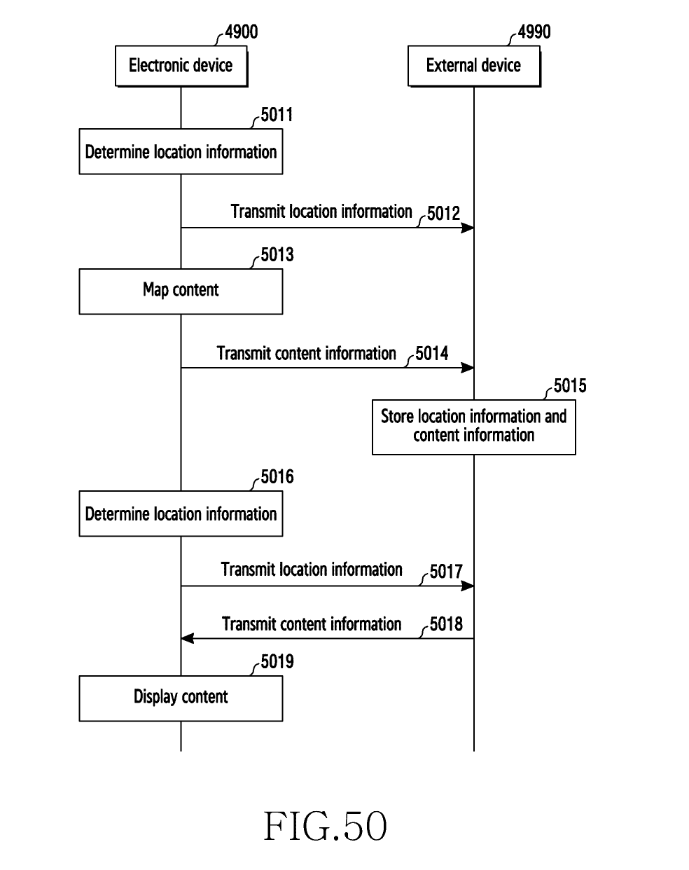

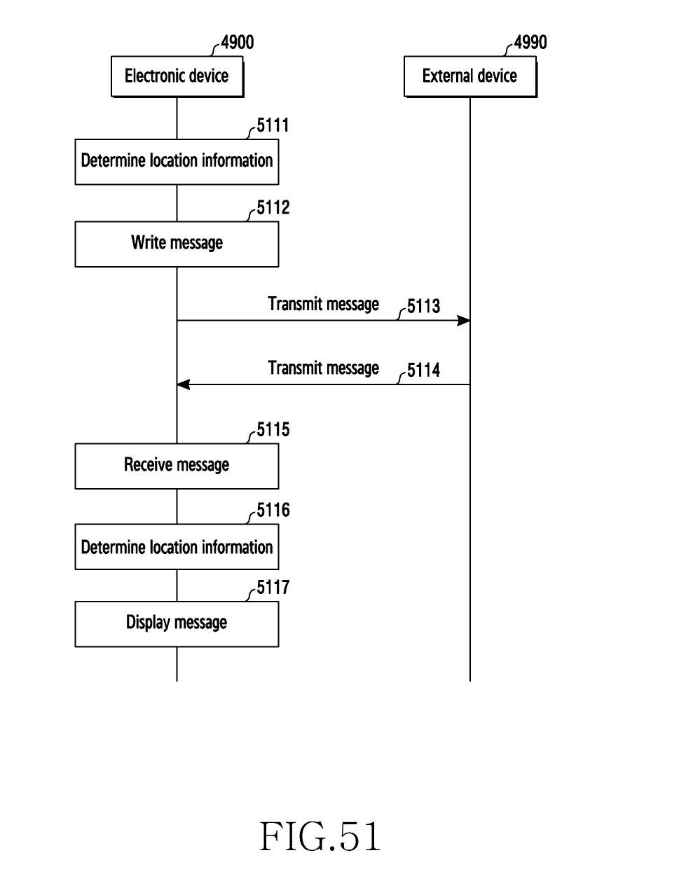

FIGS. 50 and 51 are flowcharts illustrating an example method of operation according to various example embodiments of the present disclosure.

As illustrated in FIG. 50, operation 5011 is similar to operation 411 of FIG. 4, and thus, the detailed descriptions thereof will be omitted. The electronic device 4900 may transmit determined location information to the external device 4990 in operation 5012. According to various embodiments of the present disclosure, when the unique identification of the electronic device 4900 is identified through the signal transmission/reception between the electronic device 4900 and the external device 4990, the operation of determining the location information and the operation of transmitting the location information, which are performed in operations 5011 and 5012 by the electronic device 4900 may be omitted.

Operation 5013 is similar to operation 418 of FIG. 4, and thus, the detailed descriptions thereof will be omitted. The electronic device 4900 may transmit a mapped content onto the external device 4990 in operation 5014.

The external device 4990 may store received location information and content in operation 5015. When the location information is not received from the electronic device 4900, the external device 4990 may store only a content from the electronic device 4900. According to various embodiments of the present disclosure, the external device 4990 may store the unique identification information and the content of the electronic device 4900, together.

Operation 5016 is similar to operation 411 of FIG. 4, and thus, the detailed descriptions thereof will be omitted. The electronic device 4900 may transmit the determined location information to the external device 4990 in operation 5017. According to various embodiments of the present disclosure, when the unique identification of the electronic device 4900 is identified through the signal transmission/reception between the electronic device 4900 and the external device 4990, the operation of determining the location information and the operation of transmitting the location information, which are performed by the electronic device 4900 in operations 5016 and 5017 may be omitted.

Based on the received location information, the external device 4990 may transmit a content that is mapped onto the corresponding location information in operation 5018. According to various embodiments of the present disclosure, when the location information is not received from the electronic device 4900, the external device 4990 may transmit a content using the unique identification information of the electronic device 4900.

Operation 5019 is similar to operation 414 of FIG. 4, and thus, the detailed descriptions thereof will be omitted.

As illustrated in FIG. 51, according to various embodiments of the present disclosure, an external device 5190 may enable the transmission/reception of a message among the electronic devices 4900. The electronic device 4900 determines location information in operation 5111. Operation 5111 is similar to operation 411 of FIG. 4, and thus, the detailed descriptions thereof will be omitted. The electronic device 4900 writes a message in operation 5112. Operation 5112 is similar to the operation of mapping a content onto a message, which has been described above. Operation 5112 is similar to operation 4412 of FIG. 44, and thus, the detailed descriptions thereof will be omitted. The electronic device 4900 transmits a message in operation 5113. Operation 5113 is similar to operation 4415 of FIG. 44, and thus, the detailed descriptions thereof will be omitted. The external device 5190 may be an external device for transmitting/receiving a message. When a request for transmitting a message is generated from the electronic device 4900 in operation 5113, the external device 5190 may send a corresponding message to a recipient in operation 5114. The electronic device 4900 may receive the message through the external device 5190 in operation 5115. The electronic device 4900 may determine whether the message received from the outside is a message that is mapped onto the location information. When it is determined that the received message is a mapped message, the electronic device 4900 displays the message in operation 5117 based on location information determined in operation 5116. According to an embodiment of the present disclosure, the electronic device 4900 may determine whether a message exists that is mapped onto the determined location information, and may display the message in operation 5117. Operation 5117 is similar to operation 3016 of FIG. 30, and thus, the detailed descriptions thereof will be omitted.

According to an embodiment of the present disclosure, a method of operating an electronic device may include: an operation of determining location information of an electronic device; an operation of detecting a content mapped onto the determined location information; and an operation of mapping a content to the determined location information.

According to an embodiment of the present disclosure, the operation of determining the location information may include: determining the location of the electronic device; and determining whether an object that faces the electronic device exists.

According to an embodiment of the present disclosure, the operation of determining the location of the electronic device further include: determining a directionality of the electronic device.

According to an embodiment of the present disclosure, the object is at least one out of an external device capable of performing short-range communication or an image obtained from a subject.

According to an embodiment of the present disclosure, the operation method further includes: displaying a mapped content in a display unit when a content that is mapped onto the determined location information is detected.

According to an embodiment of the present disclosure, the display unit includes a first display unit and a second display unit which is transparent; and the operation of displaying the mapped content displays the mapped content in the second display unit.

According to an embodiment of the present disclosure, the operation of detecting the mapped content includes: an operation of receiving the mapped content from an external device.

According to an embodiment of the present disclosure, the operation of mapping the content includes: an operation of displaying a mappable content in the first display unit; an operation of receiving an input that selects at least one of mappable contents; and an operation of displaying the selected content in the second display unit which is transparent.

According to an embodiment of the present disclosure, the operation of mapping the content includes: an operation of displaying at least one candidate object; an operation of receiving an input that selects one of the at least one object; and an operation of mapping the content onto the selected object.

According to an embodiment of the present disclosure, the operation of mapping the content includes: an operation of writing a message; and an operation of transmitting the message together with the determined location information.

The features, structures, effects, and the like that have been described in the above example embodiments are included in at least one embodiment of the present disclosure, and may not be limited to only one embodiment. In addition, the features, structures, effects, and the like which are illustrated in each embodiment may be modified or combined with other embodiments by skilled one in the field where the embodiments belong. Therefore, it should be construed that the combination and the modification are included in the scope of the present disclosure.

Also, although the descriptions have been provided based on the embodiments, the embodiments may not limit the present disclosure, and a person ordinarily skilled in the art to which the present disclosure pertains may make various modifications and applications that are not disclosed in the above, without departing from the scope of the present disclosure. For example, each component that is specifically described in the embodiments may be modified. It should be understood that differences associated with the modifications and the applications are included in the scope of the present disclosure determined on the basis of the accompanying claims.

What is claimed is:

1. A method of operating an electronic device, the method comprising:
determining location information of an electronic device;
detecting a content mapped to the determined location information; and
mapping a content to the determined location information.

2. The method of claim 1, wherein the determining of the location information comprises:
determining the location of the electronic device; and
determining whether an object that faces the electronic device exists.

3. The method of claim 2, wherein the determining of the location of the electronic device further comprises:
determining a directionality of the electronic device.

4. The method of claim 2, wherein the object is at least one of an external device capable of performing short-range communication and an image obtained from a subject.

5. The method of claim 1, further comprising:
displaying the mapped content in at least one display operatively coupled to the electronic when a content that is mapped onto the determined location information is detected.

6. The method of claim 5, wherein the at least one display includes a first display and a second display, the second display being transparent; and
the displaying of the mapped content displays the mapped content in the second display.

7. The method of claim 1, wherein the detecting of the mapped content comprises:
receiving the mapped content from an external device.

8. The method of claim 1, wherein the mapping of the content further comprises:
displaying a mappable content in a first display;
receiving an input selecting at least one mappable content; and
displaying the selected content in a second display, the second display being transparent.

9. The method of claim 1, wherein the mapping of the content comprises:
displaying at least one candidate object;
receiving an input selecting one of the at least one object; and
mapping the content onto the selected object.

10. The method of claim 1, wherein the mapping of the content comprises:
writing a message; and
transmitting the message together with the determined location information.

11. An electronic device, comprising:
a first display and a second display, the second display being transparent; and
a controller functionally connected to the first display and the second display,
wherein the controller is configured to: determine location information of the electronic device; detect a content that is mapped onto the determined location information; and map a content onto the determined location information.

12. The electronic device of claim 11, wherein the controller is configured to: determine the location of the electronic device; and determine whether an object that faces the electronic device exists.

13. The electronic device of claim 12, further comprising:
a sensor unit comprising at least one sensor,
wherein the sensor unit is configured to determine a directionality of the electronic device.

14. The electronic device of claim 12, wherein the object is at least one of an external device capable of performing short-range communication and an image obtained from a subject.

15. The electronic device of claim 11, wherein, the controller is configured to display the mapped content in the second display when a content that is mapped onto the determined location information is detected.

16. The electronic device of claim 15, wherein the controller is configured to display the mapped content in the second display.

17. The electronic device of claim 11, further comprising:
a communication unit comprising communication circuitry,
wherein the communication circuitry of the communication unit is configured to receive the mapped content from an external device.

18. The electronic device of claim 11, wherein the controller is configured to: display a mappable content in the first display; receive an input selecting at least one mappable content; and display the selected content in the second display of the second display.

19. The electronic device of claim 11, wherein the controller is configured to: display at least one candidate object, receive an input selecting one of the at least one object; and map the content onto the selected object.

20. The electronic device of claim 11, wherein the controller is configured to: write a message; and transmit the message together with the determined location information.
